(19) United States
(12) Patent Application Publication
(10) Pub. No.: US 2025/0330079 A1
(43) Pub. Date: Oct. 23, 2025

(54) SEMICONDUCTOR DEVICE

(71) Applicant: Renesas Electronics Corporation, Tokyo (JP)

(72) Inventor: Keisuke KIMURA, Tokyo (JP)

(21) Appl. No.: 19/069,518

(22) Filed: Mar. 4, 2025

(30) Foreign Application Priority Data
Apr. 18, 2024 (JP) 2024-067617

(51) Int. Cl. H02M 1/00; H02M 1/08; H02M 1/32; H02M 3/157; H02M 3/158

(52) U.S. Cl. CPC H02M 1/0009; H02M 1/08; H02M 1/325; H02M 3/157; H02M 3/158

(57) ABSTRACT

To provide a semiconductor device that can be miniaturized. The semiconductor device includes a power transistor H_PN, L_PN that supplies current to a load, a current detection circuit that detects the current flowing through the power transistor H_PN, L_PN, a first detection current H_DI1, L_DI1 based on the current detected by the current detection circuit, a device control circuit that controls the current flowing through the power transistor H_PN, L_PN based on an input signal Inp, an overrange comparison circuit that outputs an overrange signal H_OV, L_OV when the voltage of the power transistor H_PN, L_PN exceeds a predetermined voltage,, and an abnormal signal generation circuit that outputs an abnormal signal indicating an overcurrent state of the power transistor based on a second detection current H_DI2, L_DI2 detected by the current detection circuit and the overrange signal H_OV, L_OV.

### CROSS-REFERENCE TO RELATED APPLICATIONS

The disclosure of Japanese Patent Application No. 2024-067617 filed on Apr. 18, 2024, including the specification, drawings and abstract is incorporated herein by reference in its entirety.

### BACKGROUND

The present invention relates to a semiconductor device, for example, a semiconductor device equipped with detection technology for detecting the current of a power device that drives a load such as a coil.

There are disclosed techniques listed below.

[Patent Document 1] U.S. Pat. No. 6,377,034

[Patent Document 2] U.S. Pat. No. 10,256,725

[Patent Document 3] U.S. Pat. No. 11,385,266

Detection technology for detecting the current flowing through a power device is shown, for example, in Patent Documents 1 to 3.

Patent Document 1 shows a technique for accurately detecting current by detecting a current proportional to the current of a high-side transistor (FIG. 1: reference numeral 2), which is a power device, with a sense transistor (7), and feedback controlling with an operational amplifier (13) so that the voltage of node (11) (source voltage of sense transistor 7) becomes the same as the voltage of node (5) (source voltage of high-side transistor 2), thereby aligning the gate-source voltage and drain-source voltage of the high-side transistor (2) and the sense transistor (7).

Patent Document 2, as with Patent Document 1, shows a technique for accurately detecting current by detecting a current proportional to the current of a high-side transistor (FIG. 12: Tr1) with a sense transistor (NM1), and controlling with an operational amplifier (A1) so that the drain voltage of the sense transistor becomes the same as the drain voltage of the high-side transistor, thereby aligning the gate-source voltage and drain-source voltage of the sense transistor and the high-side transistor.

Patent Document 3 shows a technique for reducing the difference in the degree of degradation between a high-side transistor and a sense transistor by connecting a switch (SW3) between the high-side transistor (FIG. 4: MN1) and the sense transistor (Tr11), and controlling the switch (SW3) so that the source-drain voltage becomes the same when the high-side transistor and the sense transistor are in the off state.

### Prior-Art Document

[symbol]

### SUMMARY

The inventors have considered a semiconductor device that detects a current proportional to the current of a power device using the techniques shown in Patent Documents 1 to 3 and controls the power device based on the detected current. As will be explained later with reference to the drawings, the inventors have found that there is a problem in that the occupied area of the detection circuit for detecting the current of the power device becomes large.

A brief description of the representative embodiments disclosed in this application is as follows.

That is, a semiconductor device according to one embodiment includes a power device that supplies current to a load, a current detection circuit that detects the current flowing through the power device, a first detected current based on the current detected by the current detection circuit, a device control circuit that controls the current flowing through the power device based on the input signal, an over-range comparison circuit that outputs an over-range signal when the voltage of the power device exceeds a predetermined voltage, and an abnormal signal generation circuit that outputs an abnormal signal indicating an overcurrent state of the power device based on the second detected current and the over-range signal.

Other objects and novel features will become apparent from the description of this specification and the accompanying drawings.

According to one embodiment, it is possible to provide a semiconductor device that suppresses the increase in the occupied area of the detection circuit and enables miniaturization.

### BRIEF DESCRIPTION OF THE DRAWINGS

FIG. 1 is a block diagram showing the configuration of a semiconductor device according to the first embodiment.

FIG. 2 is a circuit diagram showing the configuration of a high-side detection circuit according to the first embodiment.

FIG. 3 is a circuit diagram showing the configuration of an over-range e comparison circuit according to the first embodiment.

FIGS. 4A and 4B are circuit diagrams showing the configuration of a generation circuit section according to the first embodiment.

FIG. 5 is a circuit diagram showing the configuration of a low-side detection circuit according to the first embodiment.

FIG. 6 is a circuit diagram showing the configuration of an over-range comparison circuit according to the first embodiment.

FIGS. 7A and 7B are circuit diagrams showing examples of the generation circuit section according to the first embodiment.

FIG. 8 is a waveform diagram showing the operation of the high-side detection circuit according to the first embodiment.

FIG. 9 is a waveform diagram showing the operation of the low-side detection circuit according to the first embodiment.

FIG. 10 is a circuit diagram showing the state during self-diagnosis of the high-side detection circuit according to the first embodiment.

FIGS. 11A and 11B are waveform diagrams for explaining the self-diagnosis function of the high-side detection circuit according to the first embodiment.

FIG. 12 is a circuit diagram showing the state during self-diagnosis of the low-side detection circuit according to the first embodiment.

FIG. 13 is a circuit diagram showing the state during self-diagnosis of the low-side detection circuit according to the first embodiment.

FIGS. 14A to 14D are waveform diagrams explaining the self-diagnosis function of the low-side detection circuit according to the first embodiment.

FIG. 15 is a circuit diagram showing the configuration of a high-side detection circuit according to the second embodiment.

FIG. 16 is a circuit diagram showing the configuration of an over-range comparison circuit according to the second embodiment.

FIG. 17 is a circuit diagram showing the configuration of a low-side detection circuit according to the second embodiment.

FIG. 18 is a circuit diagram showing the configuration of an over-range comparison circuit according to the second embodiment.

FIG. 19 is a block diagram showing the configuration of Comparative Example 1 for detecting the current flowing through a high-side N-type transistor.

FIG. 20 is a block diagram showing the configuration of Comparative Example 2 developed by the inventors.

FIG. 21 is a waveform diagram explaining the operation of Comparative Example 2.

FIG. 22 is a block diagram showing the configuration of Comparative Example 3 for detecting the current flowing through a low-side N-type transistor.

FIG. 23 is a block diagram showing the configuration of Comparative Example 4 developed by the inventors.

FIG. 24 is a waveform diagram for explaining the operation of Comparative Example 4.

### DETAILED DESCRIPTION

Hereinafter, embodiments of the present invention will be described with reference to the drawings. It should be noted that the disclosure is merely an example, and those skilled in the art can easily conceive of appropriate modifications without departing from the spirit of the invention, which are naturally included within the scope of the present invention.

In addition, in this specification and the drawings, elements as with those previously described with respect to the figures already presented are denoted by the same reference numerals, and detailed descriptions thereof may be omitted as appropriate.

### Study by the Inventors

The inventors considered detecting a current proportional to the current flowing through a power device, controlling the power device so that its current reaches a desired value based on the detected current, and detecting whether an abnormal overcurrent is flowing through the power device. In this case, since the power device is composed of a high-side power device that supplies current to the load and a low-side power device that draws current from the load, the inventors considered a configuration for detecting current for both the high-side and low-side power devices. In addition, the inventors considered using a field-effect transistor (hereinafter simply referred to as a transistor) as the power device. Although not particularly limited, this specification describes an example in which an N-channel transistor (hereinafter also referred to as an N-type transistor) is used as the power device, but it is not limited thereto. For example, a P-channel transistor (hereinafter also referred to as a P-type transistor) may be used as a power device.

It should be noted that the transistor includes a source terminal, a drain terminal, and a gate terminal, but in the following description, the source terminal and the drain terminal may be collectively referred to as a pair of terminals.

### High-Side Comparative Example

### Comparative Example 1

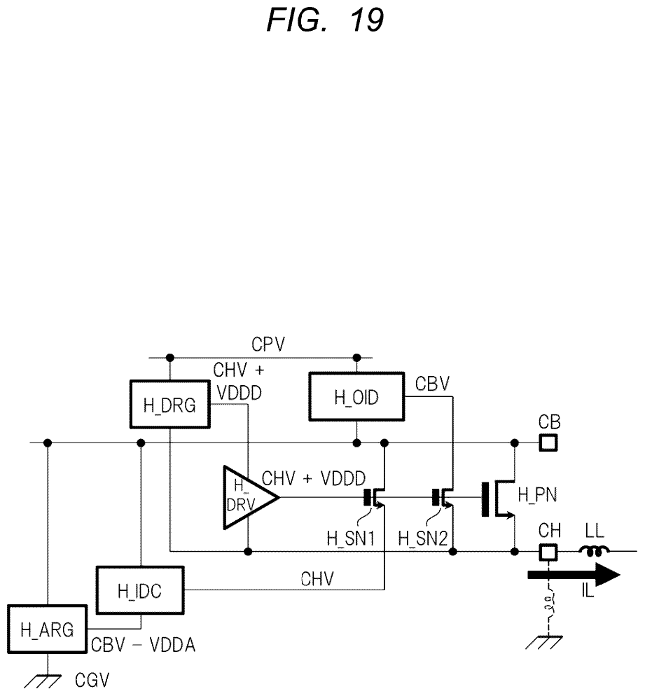

FIG. 19 is a block diagram showing the configuration of Comparative Example 1 for detecting a current proportional to the current flowing through a high-side transistor. In FIG. 19, CB indicates a power supply terminal, and for example, a power supply voltage CBV is supplied from a battery. In addition, CH indicates an output terminal to which a load is connected. In FIG. 19, a coil LL is connected as a load to the output terminal CH. Since it is high-side, current IL is supplied from the output terminal CH to the coil LL (hereinafter, arrows indicate the direction of the current).

In FIG. 19, H_PN indicates an N-type transistor (hereinafter also referred to as a power transistor) that constitutes the power device, and H_SN1 and H_SN2 indicate N-type transistors (hereinafter also referred to as sense transistors) that sense a current proportional to the current flowing through the power transistor H_PN. The drain terminals of the power transistor H_PN and the sense transistor H_SN1 are connected to the power supply terminal CB, and the source terminals of the power transistor H_PN and the sense transistor H_SN2 are connected to the output terminal CH. Additionally, the gate terminals of the power transistor H_PN and the sense transistors H_SN1, H_SN2 are commonly connected, and the output of the driver H_DRV is supplied.

The sizes of the sense transistors H_SN1, H_SN2 are made smaller than the size of the power transistor H_PN. For example, when the size of the sense transistors H_SN1, H_SN2 is set to 1, the size of the power transistor H_PN is 4000. By commonly connecting the gate terminals of the sense transistors H_SN1, H_SN2 and the power transistor H_PN and driving them with the driver H_DRV, a current proportional to the current IL flowing through the power transistor H_PN flows through the sense transistors H_SN1, H_SN2. In this case, the ratio of the current flowing through the sense transistors H_SN1, H_SN2 to the current IL flowing through the power transistor H_PN is proportional to the size of the transistors. That is, according to the size example mentioned above, the current flowing through the sense transistors H_SN1, H_SN2 is about 1/4000 of the current IL flowing through the power transistor H_PN.

The current flowing through the sense transistor H_SN1 is supplied to the current detection circuit H_IDC. This current detection circuit H_IDC is configured based on the structure shown in Patent Document 1. The current detection circuit H_IDC is connected to the power supply terminal CB and the voltage regulator H_ARG. The voltage regulator H_ARG is connected to the power supply terminal CB and the ground voltage CGV and generates a voltage CBV-VDDA by subtracting a predetermined voltage VDDA from the power supply voltage CBV fed to the power supply terminal CB. As a result, the current detection circuit H_IDC operates with the power supply voltage CBV and the voltage CBV-VDDA at the power supply terminal CB as the power supply voltage.

Although not shown in FIG. 19, a signal corresponding to the difference between the current detected by the current detection circuit H_IDC and the target current is supplied to the driver H_DRV, and the driver H_DRV drives the power transistor H_PN and the sense transistors H_SN1, H_SN2 so that the difference becomes smaller. The driver H_DRV is connected to the output terminal CH and the voltage regulator H_DRG. The voltage regulator H_DRG is connected to the voltage CPV and the output terminal CH, and generates a voltage CHV+VDDD by adding a predetermined voltage VDDD to the voltage CHV at the output terminal CH. The voltage CPV is a voltage generated by, for example, a charge pump circuit (not shown), and is higher than the power supply voltage CBV. As a result, the driver H_DRV operates with the voltage CHV+VDDD and the voltage CHV at the output terminal CH as the power supply voltage.

The current flowing through the sense transistor H_SN2 is supplied to the overcurrent detection circuit H_OID. The overcurrent detection circuit H_OID is configured based on the structure shown in Patent Document 2. The overcurrent detection circuit H_OID operates with the power supply voltage CBV and the voltage CPV at the power supply terminal CB as the power supply. This overcurrent detection circuit H_OID detects whether the current IL flowing through the power transistor H_PN has become an overcurrent exceeding a predetermined value based on the current flowing through the sense transistor H_SN2. For example, when a state where the output terminal CH is connected to the ground voltage CGV (short circuit to ground) as indicated by the dashed line occurs, the current IL flowing through the power transistor H_PN becomes an overcurrent and is detected by the overcurrent detection circuit H_OID. Although not particularly limited, when an overcurrent is detected by the overcurrent detection circuit H_OID, for example, the driver H_DRV drives the power transistor H_PN and the sense transistors H_SN1, H_SN2 to be in the off state.

According to Comparative Example 1 shown in FIG. 19, it is possible to control the current IL flowing through the power transistor H_PN to a desired value based on the current detected by the current detection circuit H_IDC. In addition, it is possible to detect whether an abnormal overcurrent is flowing through the power device by the overcurrent detection circuit H_OID.

However, in the configuration of Comparative Example 1, since the current flowing through the power transistor H_PN is detected by separate sense transistors (H_SN1 and H_SN2) and detection circuits (current detection circuit H_IDC and overcurrent detection circuit H_OID), there is a problem that the occupied area becomes large. Therefore, the inventors have developed Comparative Example 2 described below.

### Comparative Example 2

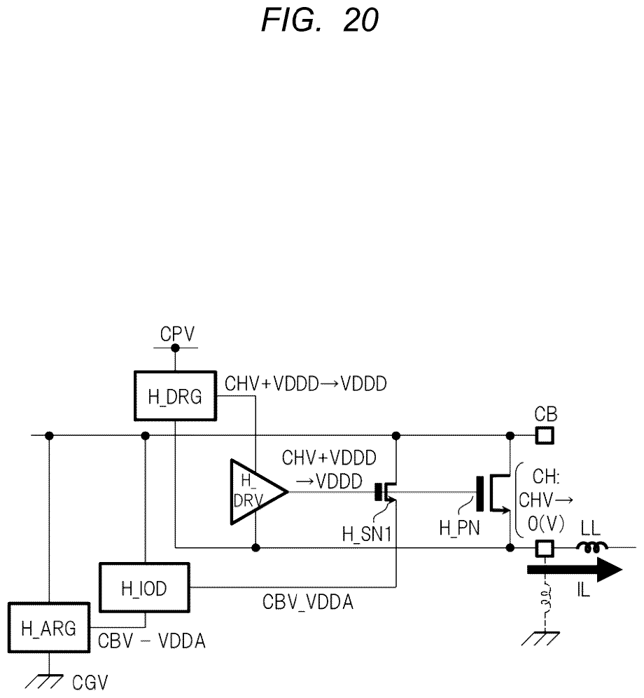

FIG. 20 is a block diagram showing the configuration of Comparative Example 2 developed by the inventors to solve the problem related to the occupied area. The main difference from Comparative Example 1 shown in FIG. 19 is that in FIG. 20, the sense transistor H_SN2 and the overcurrent detection circuit H_OID are removed, and the current flowing through the sense transistor H_SN1 is supplied to the current detection circuit and overcurrent detection circuit H_IOD instead of the current detection circuit H_IDC. The current detection circuit and overcurrent detection circuit H_IOD detects the current used to control the current IL flowing through the power transistor H_PN to a desired value based on the current flowing through the sense transistor H_SN1, and also detects overcurrent caused by the short circuit to ground, etc. By doing so, it is possible to solve the problem of the occupied area becoming large.

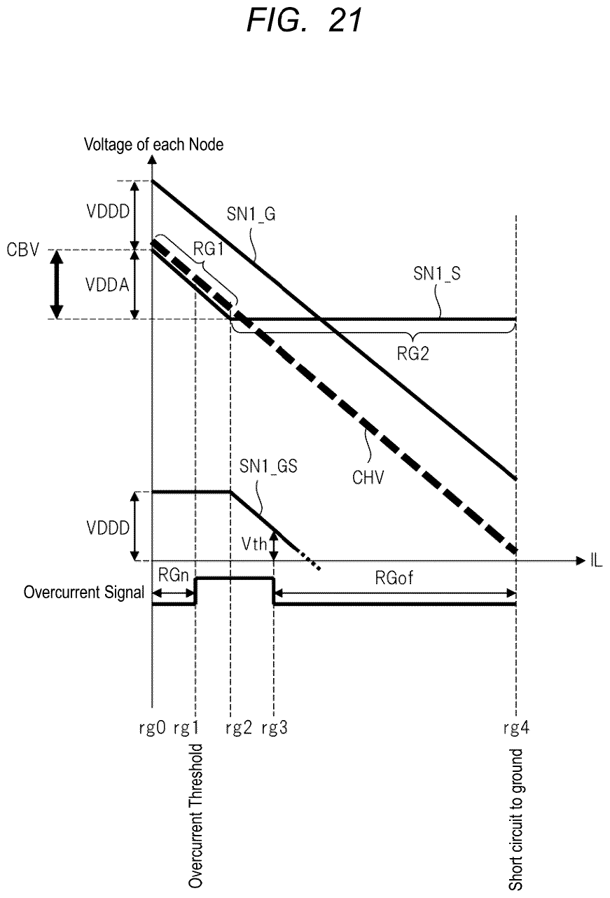

However, when the inventors further examined Comparative Example 2, as will be explained using FIG. 21, it was found that when an overcurrent flows through the power transistor H_PN due to the short circuit to ground, etc., the sense transistor H_SN1 turns off, and the current proportional to the overcurrent flowing through the power transistor H_PN is not supplied to the current detection circuit and overcurrent detection circuit H_IOD, making it impossible to detect the short circuit to ground, etc.

FIG. 21 is a waveform diagram explaining the operation of Comparative Example 2. FIG. 21 shows the transition of the output terminal CH from a normal state to the short circuit to ground (where the output terminal CH is shorted to the ground voltage CGV). In FIG. 21, the horizontal axis represents the current IL flowing through the power transistor H_PN, and the vertical axis represents the voltage of each part (node) of Comparative Example 2. The value of the current IL flowing through the power transistor H_PN increases from the value rg0 (normal state) towards the value rg4 (short circuit to ground).

In FIG. 21, SN1_G indicates the gate voltage supplied to the gate terminal of the sense transistor H_SN1 from the driver H_DRV. When the power transistor H_PN is in the on state, the voltage CHV at the output terminal CH becomes equal to the power supply voltage CBV at the power supply terminal CB, so the gate voltage SN1_G changes from the voltage CHV(=CBV)+VDDD as shown in FIG. 21.

In FIG. 21, the dashed line CHV indicates the voltage of the output terminal CH. Additionally, SN1_S indicates the source voltage of the source terminal of the sense transistor H_SN1, and SN1_GS indicates the gate-source voltage of the sense transistor H_SN1.

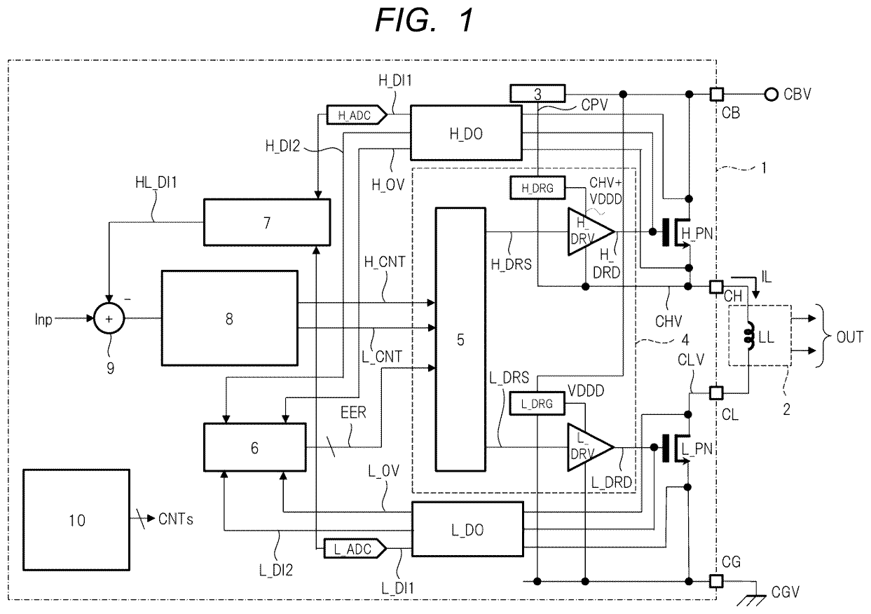

The current detection circuit and overcurrent detection circuit H_IOD is configured based on the structure shown in Patent Document 1. That is, the current detection circuit and overcurrent detection circuit H_IOD includes an operational amplifier (corresponding to reference numeral 13 in FIG. 1 of Patent Document 1) not shown, and feedback control is performed by the operational amplifier so that the source voltages of the sense transistor H_SN1 and the power transistor H_PN become equal.

In FIG. 21, in the region RG1 where the value of the current IL flowing through the power transistor H_PN is from the value rg0 to the value rg2, the source voltage SN1_S of the sense transistor H_SN1 is equal to the source voltage of the power transistor H_PN, that is, the voltage CHV of the output terminal CH, due to the feedback control by the operational amplifier in the current detection circuit and overcurrent detection circuit H_IOD. At the value rg2, when the source voltage SN1_S of the sense transistor H_SN1 falls below the lower limit operating voltage of the current detection circuit and overcurrent detection circuit H_IOD, that is, the voltage CBV-VDDA supplied from the voltage regulator H_ARG, the feedback control by the operational amplifier in the current detection circuit and overcurrent detection circuit H_IOD collapses, and the source voltage SN1_S of the sense transistor H_SN1 becomes stuck at the voltage CBV-VDDA in the region RG2.

As it moves towards the short circuit to ground, the current IL further increases, and accordingly, the voltage CHV at the output terminal CH further decreases. The voltage generated by the voltage regulator H_DRG also decreases from the voltage CHV+VDDD to the voltage VDDD, and the gate voltage SN1_G supplied to the sense transistor H_SN1 from the driver H_DRV also decreases as shown in FIG. 21. Therefore, the gate-source voltage SN1_GS of the sense transistor H_SN1 also decreases at the value rg2 as shown in FIG. 21, and at the value rg3, it becomes smaller than the threshold voltage Vth of the sense transistor H_SN1, and the sense transistor H_SN1 turns off.

The current detection circuit and overcurrent detection circuit H_IOD is not particularly limited but generates and outputs an overcurrent signal as shown in FIG. 21. Here, a value corresponding (proportional) to the value rg1 is set as the overcurrent threshold. current detection circuit and overcurrent detection circuit H_IOD keeps the overcurrent signal at a low level until the current supplied from the sense transistor H_SN1 reaches the overcurrent threshold and raises the overcurrent signal to a high level when the supplied current exceeds the overcurrent threshold. However, at the value rg3, the sense transistor H_SN1 turns off, and in the region RGof shown in FIG. 21, the sense transistor H_SN1 remains in the off state. In this region RGof, no current is supplied from the sense transistor H_SN1 to the current detection circuit and overcurrent detection circuit H_IOD, making it impossible to detect overcurrent. In FIG. 21, the region RGn indicates an area where no overcurrent flows, representing normal operation.

### Low-Side Comparative Example

### Comparative Example 3

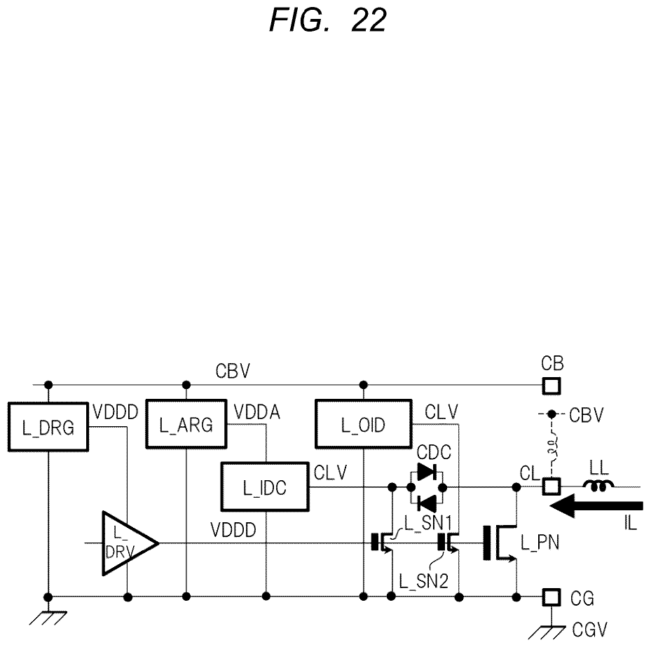

FIG. 22 is a block diagram showing the configuration of Comparative Example 3, which detects the current flowing through the low-side N-type transistor. In FIG. 22, CL indicates the output terminal, to which a load (coil LL) is connected. Since FIG. 22 shows the low side, current IL is drawn from the coil LL towards the output terminal CL.

In FIG. 22, L_PN indicates the power transistor constituting the low-side power device, and L_SN1 and L_SN2 indicate sense transistors that sense the current proportional to the current flowing through the power transistor L_PN. The source terminals of the power transistor L_PN and the sense transistors L_SN1, L_SN2 are connected to the ground terminal CG, where the ground voltage CGV is supplied, and the drain terminal of the power transistor L_PN is connected to the output terminal CL. Additionally, the drain terminal of the sense transistor L_SN1 is connected to the output terminal CL via a bidirectional circuit CDC, which is configured by connecting two diodes in parallel bidirectionally. Furthermore, the gate terminals of the power transistor L_PN and the sense transistors L_SN1, L_SN2 are commonly connected, and the output of the driver L_DRV is supplied.

The bidirectional diode circuit CDC reduces the voltage difference between the voltage at the drain terminal of the sense transistor L_SN1 and the voltage at the drain terminal of the power transistor L_PN. This bidirectional diode circuit CDC realizes a function as with the switch (SW3) shown in Patent Document 3. That is, the bidirectional diode circuit CDC operates to make the source-drain voltage of the sense transistor L_SN1 and the source-drain voltage of the power transistor L_PN approximately equal, thereby reducing the difference in the degree of degradation between the sense transistor L_SN1 and the power transistor L_PN. Moreover, by using a bidirectional diode circuit instead of the switch (SW3), the control signal for controlling the on/off of the switch (SW3) becomes unnecessary.

The size of the sense transistor is smaller than that of the power transistor, as with Comparative Example 1. For example, when the size of the sense transistors L_SN1, L_SN2 is set to 1, the size of the power transistor L_PN is 4000. As a result, by driving the sense transistors L_SN1, L_SN2 and the power transistor L_PN commonly with the driver L_DRV, a current proportional to the current IL flowing through the power transistor L_PN (about 1/4000 of the current) flows through the sense transistors L_SN1, L_SN2.

The current flowing through the sense transistor L_SN1 is supplied to the current detection circuit L_IDC. The current detection circuit L_IDC is configured based on the configuration shown in Patent Document 1. The current detection circuit H_IDC is connected to the ground terminal CG and the voltage regulator L_ARG. The voltage regulator L_ARG is connected to the power supply terminal CB and the ground terminal CG and generates a predetermined voltage VDDA from the power supply voltage CBV supplied to the power supply terminal CB. As a result, the current detection circuit L_IDC operates with the ground voltage CGV and the voltage VDDA as the power supply voltage.

Although not shown in FIG. 22, the driver L_DRV, as with the driver H_DRV shown in Comparative Example 1, is supplied with a signal corresponding to the difference between the current detected by the current detection circuit L_IDC and the target current, and the driver L_DRV drives the power transistor L_PN and the sense transistors L_SN1, L_SN2 so that the difference becomes smaller. The driver L_DRV is connected to the ground terminal CG and the voltage regulator L_DRG. The voltage regulator L_DRG is connected to the power supply terminal CB and the ground terminal CG and generates a predetermined voltage VDDD. As a result, the driver L_DRV operates with the voltage VDDD and the ground voltage CGV as the power supply voltage.

The current flowing through the sense transistor L_SN2 is supplied to the overcurrent detection circuit L_OID. The overcurrent detection circuit L_OID is configured based on the configuration shown in Patent Document 2. The overcurrent detection circuit L_OID operates with the power supply voltage CBV at the power supply terminal CB and the ground voltage CGV as the power supply voltage. This overcurrent detection circuit L_OID, as with the overcurrent detection circuit H_OID shown in Comparative Example 1, detects whether the current IL flowing through the power transistor L_PN becomes an overcurrent exceeding a predetermined value based on the current flowing through the sense transistor L_SN2. For example, when a state occurs where the output terminal CL is connected to the power supply voltage CBV (short circuit to power supply) as indicated by the dashed line, the current IL flowing through the power transistor L_PN becomes an overcurrent, which is detected by the overcurrent detection circuit L_OID. Although not particularly limited, when an overcurrent is detected by the overcurrent detection circuit L_OID, for example, the driver L_DRV drives the power transistor L_PN and the sense transistors L_SN1, L_SN2 to turn off.

According to Comparative Example 3 shown in FIG. 22, it is possible to control the current IL flowing through the power transistor L_PN to become a desired value based on the current detected by the current detection circuit L_IDC. Additionally, it is possible to detect whether an abnormal overcurrent is flowing through the power device based on the current detected by the overcurrent detection circuit L_OID. However, even in Comparative Example 3, since the current flowing through the power transistor L_PN is detected by individual sense transistors (L_SN1 and L_SN2) and detection circuits (current detection circuit L_IDC and overcurrent detection circuit L_OID), there is a problem of increased occupied area. Therefore, the inventors have developed Comparative Example 4, which will be described next.

### Comparative Example 4

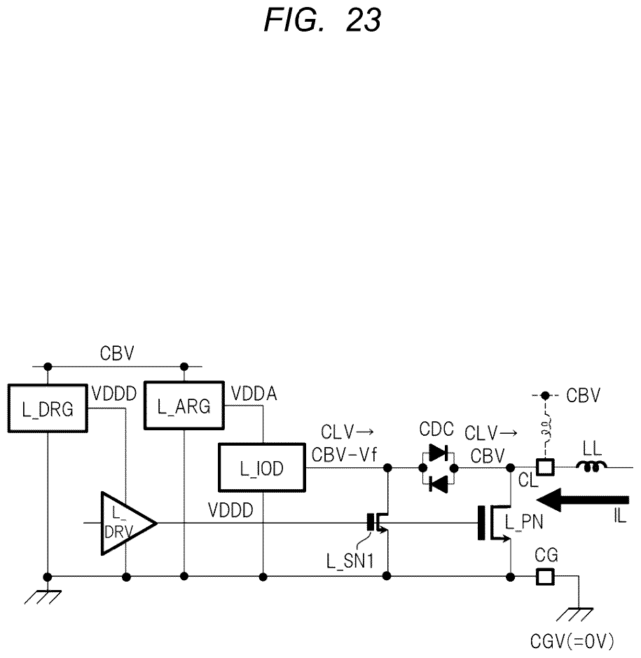

FIG. 23 is a block diagram showing the configuration of Comparative Example 4 developed by the inventors to solve the problem related to occupied area. The main difference from Comparative Example 3 shown in FIG. 22 is that in FIG. 23, the sense transistor L_SN2 and the overcurrent detection circuit L_OID are removed, and the current detected by the sense transistor L_SN1 is supplied to the current detection circuit and overcurrent detection circuit L_IOD instead of the current detection circuit L_IDC. The current detection circuit and overcurrent detection circuit L_IOD is configured to control the current IL flowing through the power transistor L_PN to become a desired value based on the current detected by the sense transistor L_SN1, and also to detect overcurrent caused by the short circuit to power supply, etc. By doing so, it is possible to solve the problem of increased occupied area.

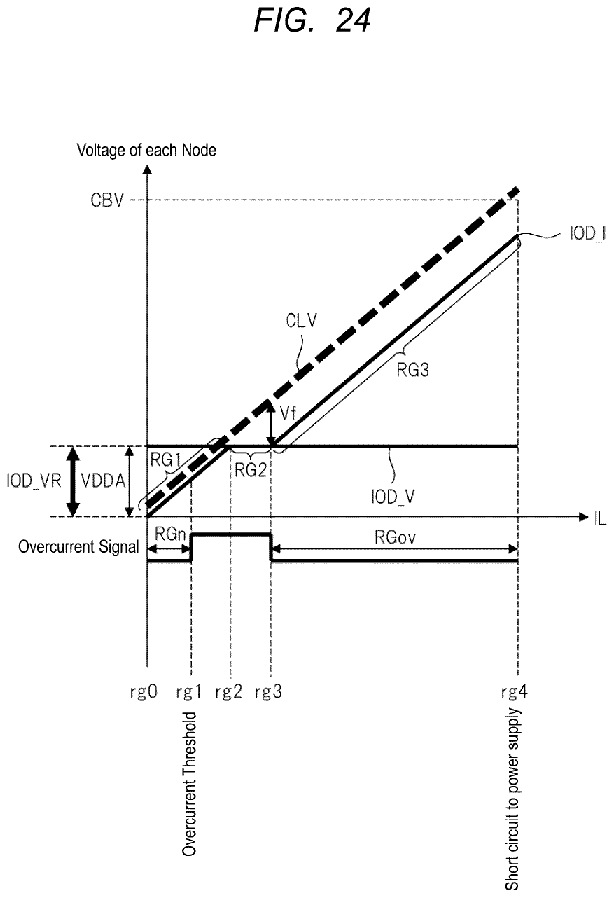

Upon further examination of Comparative Example 4 by the inventors, it was found that in Comparative Example 4, as will be explained using FIG. 24, when an overcurrent flows through the power transistor L_PN due to the short circuit to power supply, etc., the voltage is applied to the current detection circuit and overcurrent detection circuit L_IOD via the bidirectional diode circuit CDC, making it impossible to detect the short circuit to power supply, etc.

FIG. 24 is a waveform diagram for explaining the operation of Comparative Example 4. This FIG. 24 shows the transition of the output terminal CL from a normal state to the short circuit to power supply (where the output terminal CL is shorted to the power supply voltage CBV). In FIG. 24, the horizontal axis represents the current IL flowing through the power transistor L_PN, and the vertical axis represents the voltage of each part (node) in Comparative Example 4. The value of the current IL flowing through the power transistor L_PN increases from the value rg0 (normal state) towards the value rg4 (short circuit to power supply).

In FIG. 24, IOD_V indicates the power supply voltage of the current detection circuit and overcurrent detection circuit L_IOD. The current detection circuit and overcurrent detection circuit L_IOD operates with the voltage VDDA from the voltage regulator L_ARG, so its operable range IOD_VR is from the ground voltage CGV to the voltage VDDA, as indicated by the power supply voltage IOD_V. Also, in FIG. 24, IOD_I indicate the input voltage of the current detection circuit and overcurrent detection circuit L_IOD, and the dashed line CLV indicates the voltage at the output terminal CL.

The current detection circuit and overcurrent detection circuit L_IOD is configured based on the configuration shown in Patent Document 1, as with the current detection circuit and overcurrent detection circuit H_IOD described in Comparative Example 2. Namely, the current detection circuit and overcurrent detection circuit L_IOD is equipped with an operational amplifier (corresponding to reference numeral 13 in FIG. 1 of Patent Document 1) not shown in the figure, and feedback control is performed by the operational amplifier so that the drain voltages of the sense transistor L_SN1 and the power transistor L_PN become equal. In the current detection circuit and overcurrent detection circuit H_IOD of Comparative Example 2, control was performed so that the source voltages became equal through feedback control, but in the current detection circuit and overcurrent detection circuit L_IOD, control is performed so that the drain voltages become equal through feedback control.

In FIG. 24, when the value of the current IL flowing through the power transistor L_PN increases from the value rg0 and exceeds the value rg1 corresponding to the overcurrent threshold (a predetermined value) determined as overcurrent, and exists in the region RG1 up to the value rg2, the drain voltage of the sense transistor L_SN1 becomes equal to the drain voltage of the power transistor L_PN, that is, the voltage CLV of the output terminal CL, through feedback control by the operational amplifier within the current detection circuit and overcurrent detection circuit L_IOD. As shown in FIG. 24, in region RG1, the input voltage IOD_I of the current detection circuit and overcurrent detection circuit L_IOD rises similarly to the voltage CLV of the output terminal CL.

When the current IL exceeds the value rg2, and the voltage CLV of the output terminal CL rises and exceeds the power supply voltage IOD_V of the current detection circuit and overcurrent detection circuit L_IOD, the feedback control within the current detection circuit and overcurrent detection circuit L_IOD collapses, and the input voltage IOD_I becomes stuck to the power supply voltage IOD_V. If the voltage CLV of the output terminal CL rises further and becomes higher than the threshold voltage Vf of the diode constituting the bidirectional diode circuit CDC with respect to the input voltage IOD_I, the input voltage IOD_I will rise again. In FIG. 24, the range from value rg2 to value rg3 is shown as region RG2, and the range from value rg3 to value rg4 is shown as region RG3.

The current detection circuit and overcurrent detection circuit L_IOD is not particularly limited but generates and outputs an overcurrent signal as shown in FIG. 24. Here, the value corresponding to rg1 is set as the overcurrent threshold. The current detection circuit and overcurrent detection circuit L_IOD outputs the overcurrent signal as a low level indicating normal operation until the current supplied from the sense transistor L_SN1 reaches the overcurrent threshold (a value proportional to rg1), and when the supplied current exceeds the overcurrent threshold, it sets the overcurrent signal to a high level indicating abnormal operation. However, in region RG3, since the input voltage IOD_I exceeds the power supply voltage IOD_V of the current detection circuit and overcurrent detection circuit L_IOD, the current detection circuit and overcurrent detection circuit L_IOD collapses, and it becomes impossible to detect the current from the sense transistor L_SN1. Therefore, the overcurrent signal becomes a low level indicating normal operation in the region RGov corresponding to region RG3. In FIG. 24, region RGn indicates a region where no overcurrent flows, representing normal operation.

Thus, according to Comparative Examples 2 and 4, it is possible to suppress an increase in occupied area, but it is difficult to detect overcurrent caused by the short circuit to ground and/or the short circuit to power supply. In the embodiments described below, a semiconductor device is provided that can detect overcurrent, suppress occupied area, and achieve miniaturization.

### First Embodiment

### Configuration of Semiconductor Device

FIG. 1 is a block diagram showing the configuration of a semiconductor device according to the first embodiment. In FIG. 1, 1 indicates a semiconductor device. Semiconductor device 1 has multiple circuit blocks and external terminals (hereinafter simply referred to as terminals) formed, but FIG. 1 depicts only the circuit blocks and external terminals necessary for explanation. In FIG. 1, CB, CH, CL, and CG indicate external terminals provided in the semiconductor device 1, where CB is a power supply terminal (first voltage terminal), CG is a ground terminal (second voltage terminal), and CH and CL are output terminals (load terminals, first load terminal, second load terminal). To the power supply terminal CB, for example, a power supply voltage CBV (first voltage) is supplied from a battery, and to the ground terminal CG, a ground voltage CGV (second voltage) is supplied.

Load 2 is connected between the output terminals CH and CL. Not particularly limited but load 2 is constituted by a contactor such as an electromagnetic switch or relay. In FIG. 1, both ends of the coil LL constituting load 2 are connected to the output terminals CH and CL. Here, the output terminal CH is a high-side output terminal, and the output terminal CL is a low-side output terminal. Therefore, current IL is supplied from the output terminal CH to the coil LL, and current IL is drawn from the coil LL to the output terminal CL. Load 2 generates an output signal OUT based on the magnetic field generated by the current IL flowing through the coil LL.

The semiconductor device 1 includes a high-side power transistor H_PN (first power transistor), a low-side power transistor L_PN (second power transistor), a drive circuit 4, a high-side detection circuit H_DO, a low-side detection circuit L_DO, a charge pump circuit 3, a high-side analog/digital conversion circuit (hereinafter also referred to as ADC circuit) H_ADC, a low-side ADC circuit L ADC, an abnormal signal generation circuit 6, a detected current processing circuit 7, a drive control circuit 8, an arithmetic circuit 9, and a control circuit 10.

The drain terminal of the power transistor H_PN is connected to the power supply terminal CB, the source terminal is connected to the output terminal CH, and the gate terminal is connected to the drive circuit 4. The charge pump circuit 3 is connected to the power supply terminal CB and generates a voltage CPV higher than the power supply voltage CBV, supplying it to the drive circuit 4. The source terminal of the power transistor L_PN is connected to the ground terminal CG, the drain terminal is connected to the output terminal CL, and the gate terminal is connected to the drive circuit 4.

The drive circuit 4 includes a high-side driver (first driver) H_DRV, a low-side driver (second driver) L_DRV, a high-side voltage regulator (first regulator) H_DRG, a low-side voltage regulator (second regulator) L_DRG, and a drive signal generation circuit 5.

The voltage regulator H_DRG is connected to the charge pump circuit 3 and the output terminal CH and based on the voltage CPV generated by the charge pump circuit 3 and the voltage CHV at the output terminal CH, it generates a voltage CHV+VDDD by adding a predetermined value of voltage VDDD to the voltage CHV. The driver H_DRV is connected to the voltage regulator H_DRG and the output terminal CH and operates with the voltage CHV+VDDD and the voltage CHV as the power supply voltage. That is, the driver H_DRV receives the high-side drive signal H_DRS from the drive signal generation circuit 5 and supplies the drive signal H_DRD, which becomes the voltage CHV+VDDD or the voltage CHV according to the logical value of the drive signal H_DRS, to the gate terminal of the power transistor H_PN.

The voltage regulator L_DRG is connected to the power supply terminal CB and the ground terminal CG and generates a voltage VDDD of a predetermined value based on the power supply voltage CBV and the ground voltage CGV. The driver L_DRV is connected to the voltage regulator L_DRG and the ground terminal CG and operates with the voltage VDDD and the ground voltage CGV as the power supply voltage. That is, the driver L_DRV receives the low-side drive signal L_DRS from the drive signal generation circuit 5 and supplies the drive signal L_DRD, which becomes the voltage VDDD or the ground voltage CGV according to the logical value of the drive signal L_DRS, to the gate terminal of the power transistor L_PN.

The drive signal generation circuit 5 is supplied with the high-side control signal H_CNT and the low-side control signal L_CNT from the drive control circuit 8, and the abnormal signal EER from the abnormal signal generation circuit 6. The drive signal generation circuit 5 generates the drive signals H_DRS and L_DRS based on the high-side control signal H_CNT, the low-side control signal L_CNT, and the abnormal signal EER.

Not particularly limited, but the drive signal generation circuit 5 generates the drive signals H_DRS and L_DRS according to the high-side control signal H_CNT and the low-side control signal L_CNT when the abnormal signal EER does not indicate an overcurrent state. In contrast, when the abnormal signal EER indicates an overcurrent state, the drive signal generation circuit 5 generates the drive signals H_DRS and L_DRS to turn off the power transistors H_PN and L_PN, independently of the high-side control signal H_CNT and the low-side control signal L_CNT.

The high-side detection circuit H_DO, and the low-side detection circuit L_DO will be described in detail later using drawings, so they are briefly mentioned here. The detection circuit H_DO is connected to the drain terminal, source terminal, and gate terminal of the power transistor H_PN, detects a current proportional to the current IL flowing through the power transistor H_PN, and detects the voltage (source-drain voltage) of the power transistor H_PN, generating two detection currents related to the high-side (the first detection current H_DI1 and the second detection current H_DI2) and an overrange signal H_OV related to the high-side.

Similarly, the detection circuit L_DO is connected to the drain terminal, source terminal, and gate terminal of the power transistor L_PN, detects a current proportional to the current IL flowing through the power transistor L_PN, and detects the voltage (source-drain voltage) of the power transistor L_PN, generating two detection currents related to the low side (the first detection current L_DIL and the second detection current L_DI2 of the low side) and an over-range signal L_OV related to the low side.

The first detection current H_DI1 generated by the detection circuit H_DO is supplied to the high-side ADC circuit H ADC, and the first detection current converted into a digital signal by the ADC circuit H ADC is supplied to the detection current processing circuit 7. Similarly, the first detection current L_DI1 generated by the detection circuit L_DO is supplied to the low-side ADC circuit L_ADC, and the first detection current converted into a digital signal by the ADC circuit L_ADC is supplied to the detection current processing circuit 7.

The detection current processing circuit 7 generates a detection current HL_DI1, which is a digital signal proportional to the current IL flowing through the power transistors H_PN and L_PN, based on the first detection currents of the two supplied digital signals. For example, the detection current processing circuit 7 adds the two supplied first detection currents (digital signals) and generates their average value as the detection current HL_DI1.

The detection current HL_DI1 generated by the detection current processing circuit 7 is supplied to the arithmetic circuit 9. The arithmetic circuit 9 is supplied with the input signal Inp, which is a digital signal indicating the target value of the current IL flowing through the power transistors H_PN, L_PN, i.e., the current flowing through the coil LL. This input signal Inp may be supplied externally via an external terminal (not shown) provided in the semiconductor device 1, or it may be generated by a circuit block (not shown) within the semiconductor device 1. The arithmetic circuit 9 calculates the difference between the input signal Inp and the detection current HL_DI1 and supplies the calculated difference to the drive control circuit 8.

The drive control circuit 8 generates high-side control signal H_CNT and low-side control signal L_CNT with values that reduce the supplied difference and supplies them to the drive circuit 4. The high-side control signal H_CNT and low-side control signal L_CNT are, for example, PWM control signals, and the drive control circuit 8 generates PWM control signals that reduce the supplied difference. Through this feedback, the current IL supplied to the coil LL is controlled to reach the target value specified by the input signal Inp.

The second detection currents H_DI2, L_DI2 and over-range signals H_OV, L_OV generated by the detection circuits H_DO, L_DO are supplied to the abnormal signal generation circuit 6. The abnormal signal generation circuit 6 will also be explained in detail later using diagrams, so it will be briefly described here. The abnormal signal generation circuit 6 uses the second detection current and the over-range signal to determine whether an overcurrent is flowing through the power transistors H_PN, L_PN, and notifies the drive circuit 4 of the determination result with an abnormal signal EER. As mentioned earlier, when the abnormal signal EER indicates an overcurrent condition, the drive circuit 4 operates to turn off the power transistors H_PN and L_PN, protecting them from destruction. From the perspective of protection, the drive circuit 4 can be considered to have protection logic that operates based on the abnormal signal.

Control circuit 10 generates control signals CNTs, etc., to control each circuit block within the semiconductor device 1. This will be explained later using diagrams, but the detection circuits H_DO, L_DO are equipped with multiple switches composed of transistors. These switches are controlled by control signals CNTs, etc., generated by control circuit 10.

In FIG. 1, an example is shown where the load coil LL is connected between the output terminals CH and CL, but it is not limited to this. For example, the output terminals CH and CL may be used as a single common output terminal. In this case, the coil LL is connected, for example, between the common output terminal and the ground terminal CG, and the source terminal of the power transistor H_PN and the drain terminal of the power transistor L_PN are connected to the common output terminal.

In FIG. 1, it can be considered that a device control circuit is configured to control the power transistors H_PN, L_PN based on the input signal Inp and the first detection currents H_DI1, L_DI1, using the detection current processing circuit 7, drive control circuit 8, arithmetic circuit 9, and drive circuit 4.

### High-Side Detection Circuit H_DO

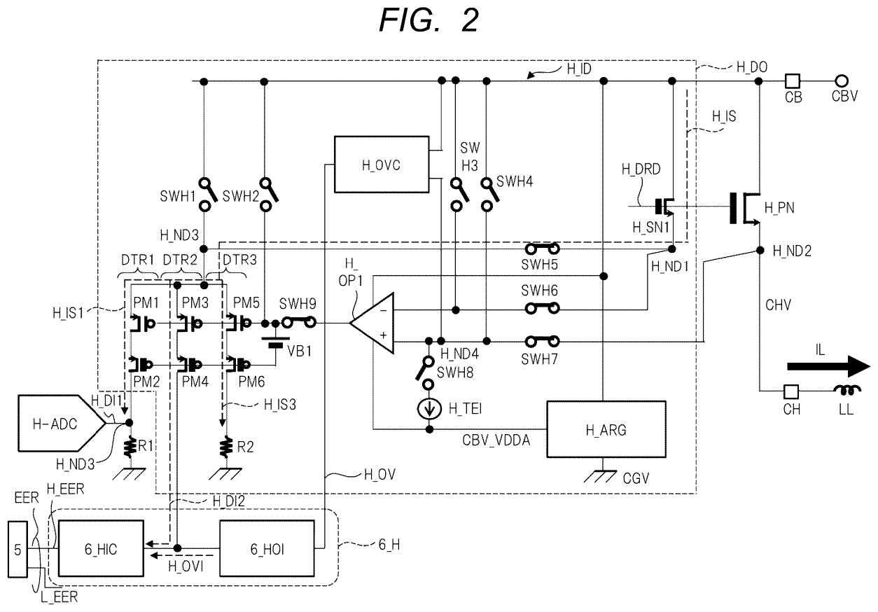

FIG. 2 is a circuit diagram showing the configuration of the detection circuit H_DO according to the first embodiment. For convenience of explanation, FIG. 2 also depicts the high-side power transistor H_PN shown in FIG. 1, and the high-side generation circuit section 6_H in the abnormal signal generation circuit 6.

The detection circuit H_DO includes a high-side over-range comparison circuit H_OVC and a high-side current detection circuit H_ID.

### Current Detection Circuit H_ID

In FIG. 2, the portion of the detection circuit H_DO shows with dashed lines, excluding the over-range comparison circuit H_OVC, corresponds to the current detection circuit H_ID. That is, the current detection circuit H_ID includes a sense transistor H_SN1 (first sense transistor), a high-side operational amplifier H_OP1, a high-side voltage regulator H_ARG, P-type transistors PM1 to PM6, a high-side diagnostic current source H_TEI, high-side switches SWH1 to SWH9, a voltage source VB1 of a predetermined value, and a resistor R2.

The switches SWH1 to SWH9 are controlled by control circuit 10 shown in FIG. 1. When detecting a current proportional to the current IL by the detection circuit H_DO, the switches SWH1 to SWH9 are controlled by control circuit 10 to be in the state shown in FIG. 2.

The drain terminal of the sense transistor H_SN1 is connected to the power supply terminal CB, the source terminal is connected to the node H ND1, and the gate terminal is connected to the gate terminal of the power transistor H_PN. The size of the sense transistor H_SN1 is smaller than that of the power transistor H_PN. Although not particularly limited, when the size of the sense transistor H_SN1 is set to 1, the size of the power transistor H_PN is 4000. The gate terminal of the sense transistor H_SN1 and the gate terminal of the power transistor H_PN are made common, and the drive signal H_DRD from the driver H_DRV is commonly supplied. As a result, the current H_IS flowing between the source and drain of the sense transistor H_SN1 is a current proportional to the current IL flowing between the source and drain of the power transistor H_PN, and the current H_IS is approximately 1/4000 of the current IL.

The inverting input terminal (−) of the operational amplifier H_OP1 is connected to the node H_ND1 via the switch SWH6, and the non-inverting input terminal (+) is connected to the node H_ND2 that connects the source terminal of the power transistor H_PN and the output terminal CH via the switch SWH7. Additionally, the power supply terminal of the operational amplifier H_OP1 is connected to the power supply terminal CB and the voltage regulator H_ARG. The voltage regulator H_ARG is connected to the power supply terminal CB and the ground voltage CGV and generates a voltage CBV-VDDA by subtracting a predetermined voltage VDDA from the power supply voltage CBV based on the power supply voltage CBV and the ground voltage CGV. As a result, the operational amplifier H_OP1 operates with the power supply voltage CBV and the voltage CBV-VDDA as the power supply voltage.

The source terminals of the P-type transistors PM1, PM3, and PM5 are connected to the node H_ND3, and the source terminals of the P-type transistors PM2, PM4, and PM6 are connected to the drain terminals of the corresponding P-type transistors PM1, PM3, and PM5. That is, the P-type transistors PM1 and PM2 are cascade-connected, the P-type transistors PM3 and PM4 are cascade-connected, and further, the P-type transistors PM5 and PM6 are cascade-connected.

The gate terminals of the P-type transistors PM1, PM3, and PM5 are connected to the output terminal of the operational amplifier H_OP1 via the switch SWH9, and the gate terminals of the P-type transistors PM2, PM4, and PM6 are connected to the gate terminals of the P-type transistors PM1, PM3, and PM5 via the voltage source VB1. Since the positive side of the voltage source VB1 is connected to the gate terminals of the P-type transistors PM1, PM3, and PM5, the output of the operational amplifier H_OP1, shifted to the negative side by the voltage of the voltage source VB1, is supplied to the gate terminals of the P-type transistors PM1, PM3, and PM5.

Additionally, the source terminal of the P-type transistor PM2 is connected to the ground voltage CGV via a resistor R1 provided outside the detection circuit H_DO, and the source terminal of the P-type transistor PM4 is connected to the high-side generation circuit section 6_H in the abnormal signal generation circuit 6 (FIG. 1) provided outside the detection circuit H_DO. Furthermore, the source terminal of the P-type transistor PM6 is connected to the ground voltage CGV via a resistor R2.

The P-type transistors PM1, PM2 and resistor R1 form a series circuit DTR1 connected between node H_ND3 and the ground voltage CGV, the P-type transistors PM3, PM4 form a series circuit DTR2 connected between node H_ND3 and the generation circuit section 6_H, and the P-type transistors PM5, PM6 and resistor R2 form a series circuit DTR3 connected between node H_ND3 and the ground voltage CGV.

Node H_ND3 is connected to node H_ND1 via switch SWH5. The series circuits DTR1 to DTR3 connected to node H_ND3 operate to shunt a current H_IS supplied from the sense transistor H_SN1 to node H_ND3, which is a current proportional to the current IL flowing through the power transistor H_PN (approximately 1/4000).

Although not particularly limited, here, when each of the shunt current H_IS1 (=first detection current H_DI1: FIG. 1) flowing through the series circuit DTR1 and the shunt current H_DI2 (=second detection current) flowing through the series circuit DTR2 is set to 1, the shunt current H_IS3 flowing through the series circuit DTR3 is set to 3, that is, the current ratio is set to 1:1:3 (DTR1:DTR2:DTR3), with the P-type transistors PM1 to PM6 and resistors R1, R2, etc. being configured accordingly.

The operational amplifier H_OP1 generates an output voltage such that the voltage at the inverting input terminal (−) (the voltage at node H_ND1) becomes equal to the voltage at the non-inverting input terminal (+) (the voltage at node H_ND2) (so that the differential voltage decreases), and supplies it to the gate terminals of the P-type transistors PM1, PM3, and PM5 from the output terminal. At this time, the output voltage of the operational amplifier H_OP1, shifted to the negative side by the voltage of the voltage source VB1, is also supplied to the gate terminals of the P-type transistors PM2, PM4, and PM6. As a result, the voltage at node H_ND3 changes according to the output voltage of the operational amplifier H_OP1, and further, the voltage at node H_ND1 changes. That is, through feedback control by the operational amplifier H_OP1, the source voltage of the sense transistor H_SN1 (the voltage at node H_ND1) is controlled to be equal to the source voltage of the power transistor H_PN (the voltage at node H_ND2).

Since the drain terminals of the sense transistor H_SN1 and the power transistor H_PN are both connected to the power supply terminal CB, through feedback control by the operational amplifier H_OP1, the source voltage of the sense transistor H_SN1 and the source voltage of the power transistor H_PN are made equal, thereby aligning the source-drain voltage of the sense transistor H_SN1 with the source-drain voltage of the power transistor H_PN. This makes it possible to accurately detect a current proportional to the current IL with the sense transistor H_SN1.

The shunt current H_IS1 (=first detection current H_DI1) flowing through the series circuit DTR1 is converted into a corresponding voltage by resistor R1 and supplied to the ADC circuit H_ADC. In contrast, the shunt current flowing through the series circuit DTR2 is supplied to the generation circuit section 6_H as the second detection current H_DI2.

Note that the high-side diagnostic current source H_TEI and switches SWH1 to SWH9 will be described later in the self-diagnosis function, so they are omitted here.

In FIG. 2, it can be considered that the first control circuit is constituted by the operational amplifier H_OP1, the P-type transistors PM1 to PM6, the resistor R2, and the voltage source VB1.

### Overrange Comparison Circuit H_OVC

The input of the overrange comparison circuit H_OVC is connected to node H_ND4 and the power supply terminal CB. Since node H_ND4 is connected to node H_ND2 via switch SWH7, the input of the overrange comparison circuit H_OVC is connected to the drain terminal and the source terminal of the power transistor H_PN. This overrange comparison circuit H_OVC compares the voltage of the power transistor H_PN (source-drain voltage) with a predetermined voltage, and if the voltage of the power transistor H_PN exceeds the predetermined voltage, it generates an overrange signal H_OV and supplies it to the generation circuit section 6_H.

### Generation Circuit Section 6_H Within the Abnormal Signal Generation Circuit 6

The generation circuit section 6_H includes an overrange current source 6_HOI and an overcurrent comparison circuit 6_HIC.

The overrange current source 6_HOI is supplied with the overrange signal H_OV, and when the overrange signal H_OV indicates that the voltage of the power transistor H_PN exceeds a predetermined voltage, it outputs an overrange current H_OVI. The second detection current H_DI2 is added to this overrange current H_OVI and supplied to the overcurrent comparison circuit 6_HIC. The overcurrent comparison circuit 6_HIC determines whether the sum of the supplied overrange current H_OVI and the second detection current H_DI2 exceeds a predetermined value, and outputs a high-side abnormal signal H EER indicating whether it exceeds or not to the drive signal generation circuit 5.

Next, an example of the overrange comparison circuit H_OVC and the generation circuit section 6_H will be described with reference to the drawings.

### An Example of the Overrange Comparison Circuit H_OVC and the Generation Circuit Section 6_H

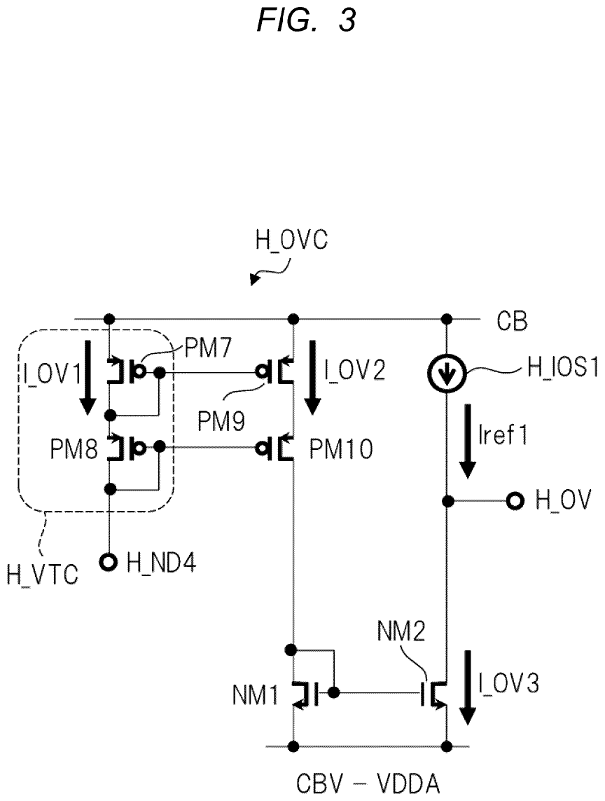

FIG. 3 is a circuit diagram showing the configuration of the overrange comparison circuit H_OVC according to the first embodiment. The overrange comparison circuit H_OVC includes P-type transistors PM7 to PM10, N-type transistors NM1, NM2, and a constant current source H_IOS1.

Each of the P-type transistors PM7, PM8 has its drain terminal and gate terminal connected, forming a diode between the source terminal and the drain terminal. The source terminal of the P-type transistor PM7 is connected to the power supply terminal CB, the source terminal of the P-type transistor PM8 is connected to the drain terminal of the P-type transistor PM7, and the source terminal of the P-type transistor PM8 is connected to node H_ND4 as the input of the overrange comparison circuit H_OVC. As a result, the two diodes formed by the P-type transistors PM7, PM8 are connected in series between the power supply terminal CB and node H_ND4. The two diodes connected in series form a reference voltage circuit H_VTC that determines the threshold voltage of the overrange comparison circuit H_OVC. In this case, the threshold voltage determined by the reference voltage circuit H_VTC is the sum of the threshold voltages of the P-type transistors PM7, PM8 that form the diodes.

The source-drain paths of the P-type transistors PM9, PM10 and the N-type transistor NM1 are connected in series between the power supply terminal CB and the voltage CBV-VDDA generated by the voltage regulator H_ARG, as shown in FIG. 3. Additionally, the gate terminals of the P-type transistors PM9, PM10 are connected to the drain terminals of the P-type transistors PM7, PM8, and the gate terminal of the N-type transistor NM1 is connected to the drain terminal of the N-type transistor NM1 and the gate terminal of the N-type transistor NM2, whose source terminal is connected to the voltage CBV-VDDA.

The constant current source H_IOS1 is connected between the power supply terminal CB and the drain terminal of the N-type transistor NM2, and the overrange signal H_OV is output from the connection node between the constant current source H_IOS1 and the N-type transistor NM2.

When the voltage at node H_ND4 decreases and the voltage at node H_ND4 falls below the threshold voltage determined by the reference voltage circuit H_VTC with respect to the power supply voltage CBV of the power supply terminal CB, a detection current I_OV1 flows through the reference voltage circuit H_VTC, and a detection current I_OV2 proportional to the detection current I_OV1 flows through the P-type transistors PM9, PM10 that form a mirror with the P-type transistors PM7, PM8. Furthermore, a detection currents I_OV3 proportional to the detection current I_OV2 flows through the N-type transistor NM2 that forms a mirror with the N-type transistor NM1. When the value of the detection current I_OV3 becomes greater than the value of the reference current Iref1 output from the constant current source H_IOS1, the overrange signal H_OV changes from high level to low level.

That is, the overrange comparison circuit H_OVC changes the overrange signal H_OV to a low level when the voltage between the power supply terminal CB and node H_ND4, that is, the voltage of the power transistor H_PN, exceeds a predetermined voltage.

In the configuration of the overrange comparison circuit H_OVC shown in FIG. 3, this predetermined voltage is mainly determined by the threshold voltage of the reference voltage circuit H_VTC and the reference current Iref1 of the constant current source H_IOS1.

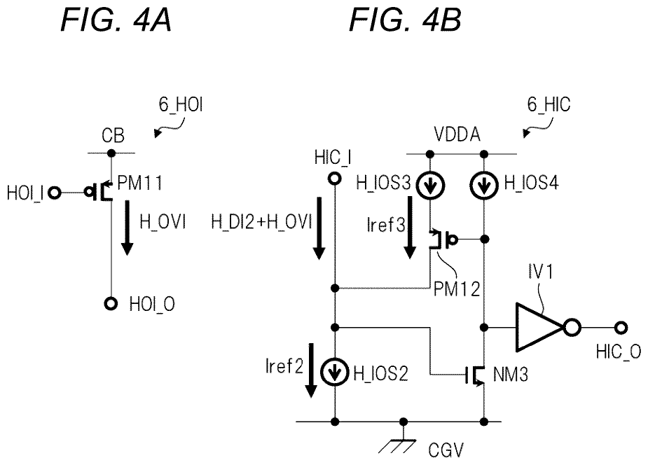

FIG. 4 is a circuit diagram showing the configuration of the generation circuit section 6_H according to the first embodiment. Here, FIG. 4A shows the configuration of the overrange current source 6_HOI, and FIG. 4B shows the configuration of the overcurrent comparison circuit 6_HIC.

In FIG. 4A, the overrange current source 6_HOI includes a P-type transistor PM11. The source terminal of this P-type transistor PM11 is connected to the power supply terminal CB, the gate terminal is connected to the input HOI_I of the overrange current source 6_HOI, and the drain terminal is connected to the output HOI_O of the overrange current source 6_HOI. An over-range signal H_OV is supplied to the input HOI_I, and an over-range current H_OVI corresponding to the over-range signal H_OV is output from the output HOI_O. That is, when the over-range signal H_OV becomes low level, the P-type transistor PM11 turns on, and the P-type transistor PM11 outputs the over-range current H_OVI.

The overcurrent comparison circuit 6_HIC, as shown in FIG. 4B, includes a P-type transistor PM12, an N-type transistor NM3, an inverter circuit IV1, and constant current sources H_IOS2 to H_IOS4.

The constant current source H_IOS2 is connected between the input HIC_I of the overcurrent comparison circuit 6_HIC and the ground voltage CGV, and the sum of the second detection current H_DI2 and the over-range current H_OVI (H_DI2+H_OVI) is supplied to this input HIC_I.

Additionally, the input HIC_I am connected to the gate terminal of the N-type transistor NM3, the source terminal of the N-type transistor NM3 is connected to the ground voltage CGV, and the drain terminal of the N-type transistor NM3 is connected to the input of the inverter circuit IV1. The gate terminal of the P-type transistor PM12 is connected to a predetermined voltage VDDA via the constant current source H_IOS4 and is also connected to the input of the inverter circuit IV1.

Furthermore, the source terminal of the P-type transistor PM12 is connected to the voltage VDDA via the constant current source H_IOS3, and the drain terminal is connected to the input HIC_I. The current Iref3 flowing through the P-type transistor PM12 is a current for generating hysteresis. The current Iref3 for generating hysteresis is added to the current (H_DI2+H_OVI) supplied to the input HIC_I. The difference between the added current (H_DI2+H_OVI+Iref3) and the reference current Iref2 generated by the constant current source H_IOS2 is determined, and the N-type transistor NM3 is turned on or off according to the difference. Functionally, a comparison is made between the added current (H_DI2+H_OVI+Iref3) and the reference current Iref2, and the N-type transistor NM3 is turned on or off based on the comparison result. Due to the on/off state of this N-type transistor NM3, the value of the current Iref3 for generating hysteresis changes, so the overcurrent comparison circuit 6_HIC has hysteresis characteristics, which can reduce malfunctions due to noise, for example.

If the added current (H_DI2+H_OVI+Iref3) exceeds the desired current value, which is the reference current Iref2, the N-type transistor NM3 turns on, and a high-level abnormal signal H_EER is output from the output HIC_O of the inverter circuit IV1.

### Low-Side Detection Circuit L_DO

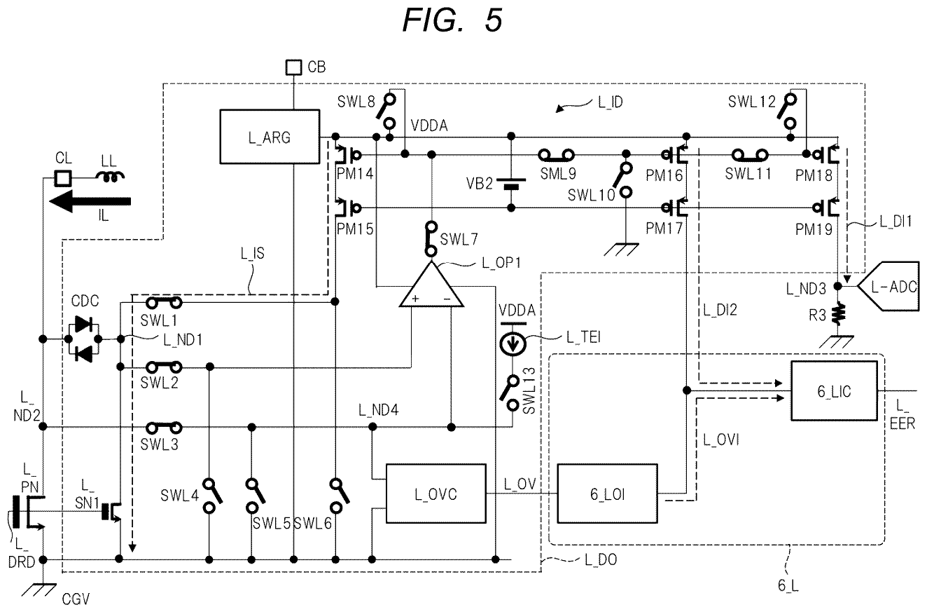

FIG. 5 is a circuit diagram showing the configuration of the detection circuit L_DO according to the first embodiment. For convenience of explanation, FIG. 5 also depicts the low-side power transistor L_PN shown in FIG. 1, the low-side generation circuit section 6_L in the abnormal signal generation circuit 6, and so on.

The detection circuit L_DO includes a low-side over-range comparison circuit L_OVC and a low-side current detection circuit L_ID.

### Current Detection Circuit L_ID

In the detection circuit L_DO shown in FIG. 5 (within the dashed lines), the portion excluding the over-range comparison circuit L_OVC corresponds to the current detection circuit L_ID. That is, the current detection circuit L_ID includes a sense transistor L_SN1 (second sense transistor), a low-side operational amplifier L_OP1, a low-side voltage regulator L_ARG, P-type transistors PM14 to PM19, a low-side diagnostic current source L_TEI, low-side switches SWL1 to SWH12, a voltage source VB2 of a predetermined value, and a bidirectional diode circuit CDC.

The switches SWL1 to SWL12 are switch-controlled by control circuit 10 shown in FIG. 1. When detecting a current proportional to the current IL by the detection circuit L_DO, the control circuit 10 switch-controls the switches SWL1 to SWL12 to be in the state shown in FIG. 5.

The source terminal of the sense transistor L_SN1 is connected to the ground voltage CGV, the drain terminal is connected to the node L_ND1, and the gate terminal is connected to the gate terminal of the power transistor L_PN. The size of the sense transistor L_SN1 is smaller than the size of the power transistor L_PN. On the low side, although not particularly limited, when the size of the sense transistor H_SN1 is set to 1, the size of the power transistor L_PN is 4000. The gate terminal of the sense transistor L_SN1 and the gate terminal of the power transistor L_PN are made common, and the drive signal L_DRD from the driver L_DRV is commonly supplied. As a result, the current L_IS flowing between the source and drain of the sense transistor L_SN1 is a current proportional to the current IL flowing between the source and drain of the power transistor L_PN, and the current L_IS is approximately 1/4000 of the current IL.

A bidirectional diode circuit (bidirectional circuit) CDC is connected between the node L_ND1 and the drain terminal of the power transistor L_PN. As a result, the voltage difference between the voltage at the drain terminal of the sense transistor L_SN1 and the voltage at the drain terminal of the power transistor L_PN is reduced. This bidirectional diode circuit CDC realizes a function as with the switch (SW3) shown in Patent Document 3. That is, the bidirectional diode circuit CDC operates to make the source-drain voltage of the sense transistor L_SN1 and the source-drain voltage of the power transistor L_PN substantially equal, thereby reducing the difference in the degree of degradation between the sense transistor L_SN1 and the power transistor L_PN. Also, by using the bidirectional diode circuit CDC instead of the switch (SW3), a control signal for controlling the on/off of the switch (SW3) becomes unnecessary.

The non-inverting input terminal (+) of the operational amplifier L_OP1 is connected to the node L_ND1 via the switch SWL2, and the inverting input terminal (−) is connected to the node L_ND2 that connects the drain terminal of the power transistor L_PN and the output terminal CL via the switch SWL3. Additionally, the power supply terminal of the operational amplifier L_OP1 is connected to the ground voltage CGV and the voltage regulator L_ARG. The voltage regulator L_ARG is connected to the power supply terminal CB and the ground voltage CGV and generates a predetermined voltage VDDA lower than the power supply voltage CBV (see FIG. 1) based on the power supply voltage CBV and the ground voltage CGV. As a result, the operational amplifier L_OP1 operates with the voltage VDDA and the ground voltage CGV as the power supply voltage.

The source terminals of the P-type transistors PM14, PM16, and PM18 are connected to the voltage VDDA, and the drain terminals are connected to the source terminals of the corresponding P-type transistors PM15, PM17, and PM19. The gate terminal of the P-type transistor PM14 is connected to the output terminal of the operational amplifier L_OP1 via the switch SWL7, further connected to the gate terminal of the P-type transistor PM16 via the switch SWL9, and the P-type transistor PM18 is connected to the gate terminal of the P-type transistor PM16 via the switch SWL11. The gate terminals of the P-type transistors PM15, PM17, and PM19 are connected to the negative side of the voltage source VB2 of a predetermined voltage, with the positive side connected to the voltage VDDA.

The P-type transistors PM14 and PM15 are cascade-connected, the P-type transistors PM16 and PM17 are also cascade-connected, and further, the P-type transistors PM18 and PM19 are also cascade-connected.

The drain terminal of the P-type transistor PM15 is connected to the node L_ND1 via the switch SWL1, the drain terminal of the P-type transistor PM17 is connected to the generation circuit section 6_L in the abnormal signal generation circuit 6, and the drain terminal of the P-type transistor PM19 is connected to the node L_ND3. The node L_ND3 is connected to the ground voltage CGV via the resistor R3 and is further connected to the input of the ADC circuit L-ADC.

The cascade-connected P-type transistors PM14, PM15, PM16, PM17, PM18, and PM19 form a current mirror. That is, a current proportional to the current flowing through the cascade-connected P-type transistors PM14 and PM15 flows through the cascade-connected P-type transistors PM16, PM17, and the cascade-connected P-type transistors PM18, PM19. Although not particularly limited, in the first embodiment, by setting the sizes of the P-type transistors PM14 to PM19, the value of the resistor R3, etc., when the current flowing through the cascade-connected P-type transistors PM18, PM19, and the cascade-connected P-type transistors PM16, PM17 is set to 1, the current flowing through the cascade-connected P-type transistors PM14, PM15 is set to 5.

Since the drain terminal of the P-type transistor PM15 is connected to the node L_ND1 and the sense transistor L_SN1 via the switch SWL1, the current through the cascade-connected P-type transistors PM14 and PM15 becomes a current L_IS proportional to the current IL flowing through the power transistor L_PN. The cascaded P-type transistors PM16 and PM17 supply a current proportional to the current L_IS as the second detection current L_DI2 to the generation circuit section 6_L. Additionally, the cascaded P-type transistors PM18 and PM19 supply a current proportional to the current L_IS as the first detection current L_DI1 to node L_ND3. The first detection current L_DI1 is converted into a voltage by the resistor R3 and then converted into a digital signal by the ADC circuit L-ADC.

The operational amplifier L_OP1 generates an output voltage such that the voltage at the non-inverting input terminal (+) (the voltage at node L_ND1) equals the voltage at the inverting input terminal (−) (the voltage at node L_ND2) (so that the differential voltage decreases), and supplies it to the gate terminals of the P-type transistors PM14, PM16, and PM18 via the switch SWL7 from the output terminal. As a result, the voltage at node L_ND1 changes according to the output voltage of the operational amplifier L_OP1. That is, the feedback control by the operational amplifier L_OP1 controls the drain voltage of the sense transistor L_SN1 to be equal to the drain voltage of the power transistor L_PN.

Since the source terminals of the sense transistor L_SN1 and the power transistor L_PN are both connected to the ground voltage CGV, the feedback control by the operational amplifier L_OP1 equalizes the drain voltage of the sense transistor L_SN1 and the drain voltage of the power transistor L_PN, thereby aligning the source-drain voltage of the sense transistor L_SN1 with the source-drain voltage of the power transistor L_PN. As a result, it becomes possible to accurately detect a current proportional to the current IL with the sense transistor L_SN1.

The low-side diagnostic current source L_TEI and switches SWL1 to SWL13 will be described later in the self-diagnostic function, so they are omitted here.

In FIG. 5, the operational amplifier L_OP1, P-type transistors PM14 to PM19, and the voltage source VB2 can be considered to constitute the second control circuit.

### Overrange Comparison Circuit L_OVC

The input of the overrange comparison circuit L_OVC is connected to node L_ND4 and the ground voltage CGV. Since node L_ND4 is connected to node L_ND2 via switch SWL3, the input of the overrange comparison circuit L_OVC is connected to the drain and source terminals of the power transistor L_PN. This overrange comparison circuit L_OVC compares the voltage (source-drain voltage) of the power transistor L_PN with a predetermined voltage, and if the voltage of the power transistor L_PN exceeds the predetermined voltage, it generates an overrange signal L_OV and supplies it to the generation circuit section 6_L within the abnormal signal generation circuit 6.

### Generation Circuit Section 6_L Within the Abnormal Signal Generation Circuit 6

The generation circuit section 6_L includes an overrange current source 6_LOI and an overcurrent comparison circuit 6_LIC.

The overrange current source 6_LOI is supplied with the overrange signal L_OV, and when the overrange signal L_OV indicates that the voltage of the power transistor L_PN exceeds a predetermined voltage, it outputs an overrange current L_OVI. The second detection current L_DI2 is added to this overrange current L_OVI and supplied to the overcurrent comparison circuit 6_LIC. The overcurrent comparison circuit 6_LIC determines whether the sum of the supplied overrange current L_OVI and the second detection current L_DI2 exceeds a predetermined value, and outputs a low-side abnormal signal L_EER indicating whether it exceeds to the drive signal generation circuit 5 (FIG. 1). The abnormal signal EER shown in FIG. 1 is a combined signal of the abnormal signal H_EER shown in FIG. 2 and the abnormal signal L_EER shown in FIG. 5.

Next, an example of the overrange comparison circuit L_OVC will be described with reference to the drawings.

### Example of Overrange Comparison Circuit L_OVC

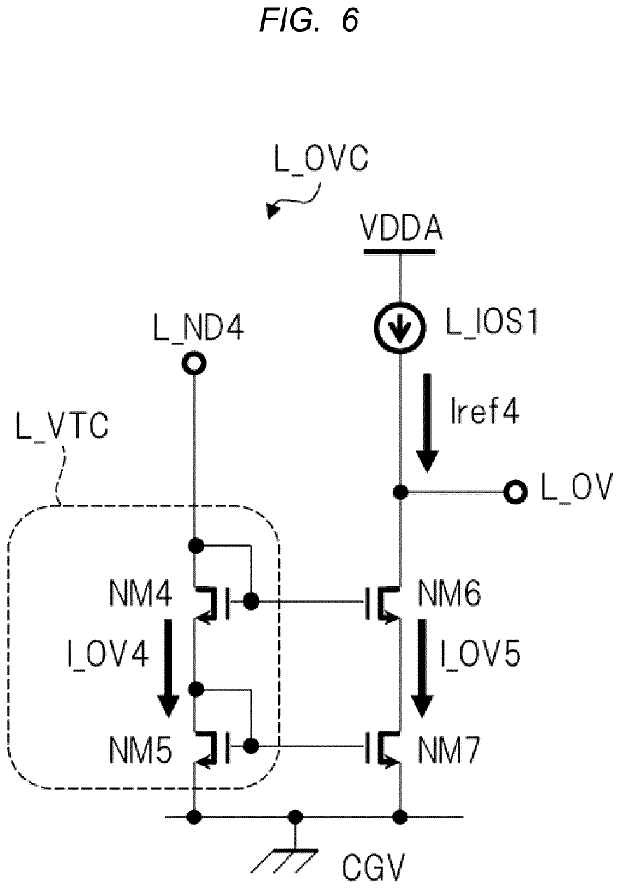

FIG. 6 is a circuit diagram showing the configuration of the overrange comparison circuit L_OVC according to the first embodiment. The overrange comparison circuit L_OVC includes N-type transistors NM4 to NM7 and a constant current source L_IOS1.

Each of the N-type transistors NM4 and NM5 has its drain terminal and gate terminal connected, forming a diode between the source terminal and the drain terminal. The source terminal of the N-type transistor NM5 is connected to the ground voltage CGV, the drain terminal of the N-type transistor PM5 is connected to the source terminal of the N-type transistor NM4, and the drain terminal of the N-type transistor NM4 is connected to node L_ND4 as the input of the overrange comparison circuit L_OVC. As a result, the two diodes formed by the N-type transistors NM4 and NM5 are connected in series between the ground voltage CGV and node L_ND4. The two diodes connected in series form a reference voltage circuit L_VTC that determines the threshold voltage of the overrange comparison circuit L_OVC. In this case, the threshold voltage determined by the reference voltage circuit L_VTC is the sum of the threshold voltages of the N-type transistors NM4 and NM5 that form the diodes.

The source-drain paths of the N-type transistors NM7 and NM6 and the constant current source L_IOS1 are connected in series between the ground voltage CGV and the voltage VDDA generated by the voltage regulator L_ARG (FIG. 5), as shown in FIG. 6. Additionally, the gate terminals of the N-type transistors NM6 and NM7 are connected to the drain terminals of the N-type transistors NM4 and NM5 to form a mirror with them. The overrange signal L_OV is output from the connection node between the constant current source L_IOS1 and the N-type transistor NM6.

For example, if the output terminal CL is connected to the power supply voltage CBV due to the short circuit to power supply, and the voltage at nodes L_ND2 and L_ND4 rises, and the voltage at node L_ND4 exceeds the threshold voltage determined by the reference voltage circuit L_VTC relative to the ground voltage CGV, the detection current I_OV4 flows through the reference voltage circuit L_VTC, and a detection current I_OV5 proportional to the detection current I_OV4 flows through the N-type transistors NM6 and NM7 that form the mirror. When the value of the detection current I_OV5 becomes greater than the value of the reference current Iref4 output from the constant current source L_IOS1, the overrange signal L_OV changes from high level to low level.

That is, the overrange comparison circuit L_OVC changes the overrange signal L_OV to a low level when the voltage between the ground terminal CG and node L_ND4, i.e., the voltage of the power transistor L_PN, exceeds a predetermined voltage. In the configuration of the overrange comparison circuit L_OVC shown in FIG. 6, this predetermined voltage is mainly determined by the threshold voltage of the reference voltage circuit L_VTC and the reference current Iref4 of the constant current source L_IOS1.

### Example of Generation Circuit Section 6_L

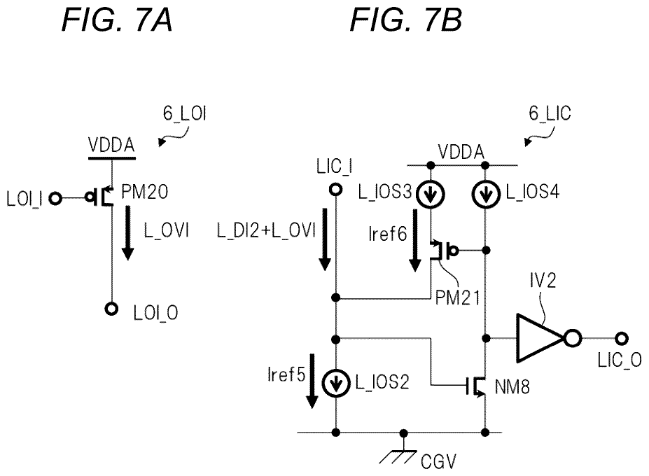

The generation circuit section 6_L, as shown in FIG. 5, includes an overrange current source 6_LOI and an overcurrent comparison circuit 6_LIC. FIG. 7 is a circuit diagram showing an example of the generation circuit section 6_L according to the first embodiment. Here, FIG. 7A shows the configuration of the overrange current source 6_LOI, and FIG. 7B shows the configuration of the overcurrent comparison circuit 6_LIC.

FIG. 7A is as with FIG. 4A. The main difference is that the source terminal of the P-type transistor PM20 corresponding to the P-type transistor PM11 in FIG. 4A is connected to the voltage VDDA generated by the voltage regulator L_ARG (FIG. 5) instead of the power supply terminal CB.

When the overrange signal L_OV is supplied to the input LOI_I of the overrange current source 6_LOI, the overrange current L_OVI according to the overrange signal L_OV is output from the output LOI_O.

FIG. 7B is as with FIG. 4B. The difference is that only the symbols have been changed. That is, the configuration and operation of the overcurrent comparison circuit 6_LIC shown in FIG. 7B are as with those of the overcurrent comparison circuit 6_HIC shown in FIG. 4B, but only the symbols indicating transistors, constant current sources, and inverter circuits have been changed. Therefore, a detailed description of the overcurrent comparison circuit 6_LIC is omitted.

The sum of the second detection current L_DI2 and the overrange current L_OVI (L_DI2+L_OVI) is supplied to the input LIC_I of the overcurrent comparison circuit 6_LIC. The N-type transistor NM8 turns on/off depending on whether the sum of the current (L_DI2+L_OVI) and the current for hysteresis generation Iref6 (L_DI2+L_OVI+Iref6) exceeds the reference current Iref5. If an overcurrent flows through the power transistor L_PN, the sum of the current (L_DI2+L_OVI+Iref6) exceeds the reference current Iref5, the N-type transistor NM8 turns on, and a high-level abnormal signal L_EER is output from the output LIC_O.

### Operation of Detection Circuits H_DO and L_DO

Next, the operation of the high-side detection circuit H_DO shown in FIG. 2 and the low-side detection circuit L_DO shown in FIG. 5 will be described with reference to the drawings.

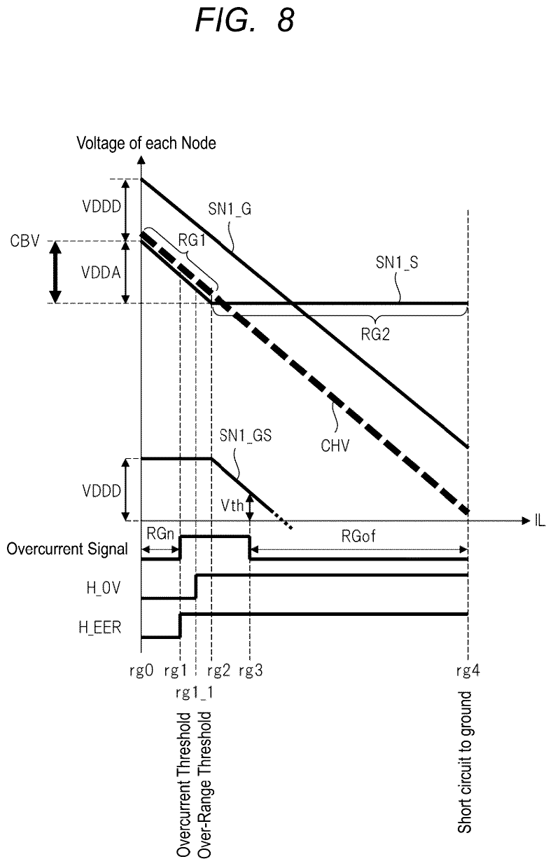

FIG. 8 is a waveform diagram showing the operation of the high-side detection circuit according to the first embodiment. FIG. 8 is as with FIG. 21. The main difference is that in FIG. 8, the over-range signal H_OV and the error signal H EER are added. Also, while FIG. 21 shows detection by the current detection circuit and overcurrent detection circuit H_IOD (FIG. 20), FIG. 8 shows detection by the detection circuit H_DO of FIG. 2. For example, the feedback control performed in region RG1 of FIG. 8 is realized by the operational amplifier H_OP1 shown in FIG. 2.

In FIG. 8, the overcurrent threshold corresponds to the threshold of the overcurrent comparison circuit 6_HIC. Taking the overcurrent comparison circuit 6_HIC shown in FIG. 4B as an example, the overcurrent threshold is mainly determined by the reference currents Iref2 and Iref3. Also, the overcurrent signal shown in FIG. 8 corresponds to the second detection current H_DI2. In the first embodiment, the second detection current H_DI2 is an analog value. Therefore, when the second detection current H_DI2 exceeds the overcurrent threshold, FIG. 8 shows this as the timing when the level of the overcurrent signal changes to high.

In FIG. 8, the over-range threshold (value corresponding to rg1_1) corresponds to the threshold of the over-range comparison circuit H_OVC. Taking the over-range comparison circuit H_OVC shown in FIG. 3 as an example, the threshold of the over-range comparison circuit H_OVC is mainly determined by the values of the reference voltage circuit H_VTC and the reference current Iref1. In FIG. 8, the state where the over-range signal H_OV exceeds the over-range threshold is depicted as the high level of the over-range signal H_OV.

In FIG. 8, region RG1 is the area where the source voltage of the sense transistor H_SN1 is equal to the source voltage of the power transistor H_PN due to feedback control by the operational amplifier H_OP1 (FIG. 2). In this region RG1, where the second detection current H_DI2 has not reached the overcurrent threshold, the overcurrent signal is at a low level, indicating no overcurrent is flowing, and it is the normal operation region RGn.

When the current IL flowing through the power transistor H_PN is between the values rg0 and rg1_1, the voltage CHV at the output terminal CH does not significantly drop, and the voltage at the node H_ND2 (=H_ND4), which is the source terminal of the power transistor H_PN, does not exceed the over-range threshold. Therefore, in the region from value rg0 to value rg1_1, the over-range signal H_OV is at a low level. In the region RGn where both the overcurrent signal and the over-range signal H_OV are at low levels, the error signal H EER is at a low level, indicating that no overcurrent due to the short circuit to ground, etc., is occurring. Also, in region RGn, the current IL output from the power transistor H_PN is detected by the current detection circuit H_ID (FIG. 2) and is controlled to be a value according to the input signal Inp (FIG. 1).

When the current IL flowing through the power transistor H_PN reaches the value rg1, the second detection current H_DI2 reaches the overcurrent threshold. As a result, as shown in FIG. 8, the overcurrent signal changes to a high level, and the error signal H_EER also changes to a high level. When the error signal H_EER becomes high, it is recognized that an abnormal current is occurring due to the short circuit to ground that connects the output terminal CH to the ground voltage CGV, and the drive circuit 4 shown in FIG. 1 turns off the power transistor H_PN. This makes it possible to prevent the power transistor H_PN from being destroyed.

Thereafter, when the current IL flowing through the power transistor H_PN reaches the value rg1_1, the voltage at node H_ND4 reaches the over-range threshold, and the over-range signal H_OV changes from low to high level. On the other hand, when the current IL reaches the value rg2, the feedback control by the operational amplifier H_OP1 collapses, reducing the gate-source voltage of the sense transistor H_SN1, and when the current IL reaches the value rg3, the gate-source voltage falls below the threshold voltage Vth of the sense transistor H_SN1, turning it off. As a result, the overcurrent signal changes from high to low level again. At this time, since the voltage at node H_ND4 continues to exceed the over-range threshold, the over-range signal H_OV maintains a high level. As a result, the error signal H_EER maintains a high level even if the current IL exceeds the value rg3, indicating that the occurrence of overcurrent due to the short circuit to ground, etc., is continuing. Also, by maintaining the high level of the error signal H_EER, the drive circuit 4 shown in FIG. 1 continues to keep the power transistor H_PN in the off state.

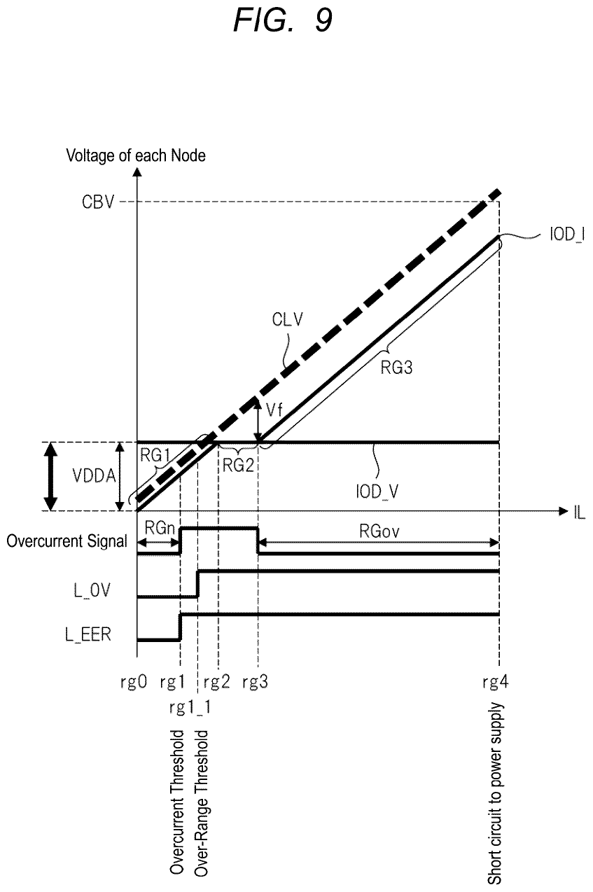

FIG. 9 is a waveform diagram showing the operation of the low-side detection circuit according to the first embodiment. FIG. 9 is as with FIG. 24. The main difference is that in FIG. 9, the over-range signal L_OV and the error signal L_EER are added. Also, while FIG. 24 shows detection by the current detection circuit and overcurrent detection circuit L_IOD (FIG. 23), FIG. 9 shows detection by the detection circuit L_DO of FIG. 5. For example, the feedback control performed in region RG1 of FIG. 9 is realized by the operational amplifier L_OP1 shown in FIG. 5. Note that in FIG. 9, IOD_I indicates the input voltage (node L_ND2) of the current detection circuit L_ID, and IOD_V indicates the power supply voltage of the current detection circuit L_ID. The current detection circuit L_ID operates with the voltage VDDA from the voltage regulator L_ARG, so its operable range is from the ground voltage CGV to the voltage VDDA, as indicated by the power supply voltage IOD_V.

In FIG. 9, the overcurrent threshold corresponds to the threshold of the overcurrent comparison circuit 6_LIC. Taking the overcurrent comparison circuit 6_LIC shown in FIG. 7B as an example, the overcurrent threshold is mainly determined by the reference current Iref5 and the current Iref6. Also, the overcurrent signal shown in FIG. 9 corresponds to the second detection current L_DI2. In the first embodiment, the second detection current L_DI2 is also an analog value. Therefore, when the second detection current L_DI2 exceeds the overcurrent threshold, FIG. 9 shows this as the timing when the level of the overcurrent signal changes to high.

In FIG. 9, the over-range threshold corresponds to the threshold of the over-range comparison circuit L_OVC. Taking the over-range comparison circuit L_OVC shown in FIG. 6 as an example, the threshold of the over-range comparison circuit L_OVC is mainly determined by the values of the reference voltage circuit L_VTC and the reference current Iref4. In FIG. 9, the state where the over-range signal L_OV exceeds the over-range threshold is depicted as the high level of the over-range signal L_OV.

In FIG. 9, region RG1 is the area where the drain voltage of the sense transistor L_SN1 is controlled to be equal to the drain voltage of the power transistor L_PN due to feedback control by the operational amplifier L_OP1 (FIG. 5). In this region RG1, when the current IL flowing through the power transistor L_PN rises from the value rg0 to the value rg1, the second detection current L_DI2 also rises, and when the current IL reaches the value rg1, the second detection current L_DI2 reaches the overcurrent threshold, and the overcurrent signal changes from low to high level. Due to this change in the overcurrent signal, the error signal L_EER also changes from low to high level. When the error signal L_EER becomes high, the abnormality is recognized, and the drive circuit 4 turns off the power transistor L_PN.

When the current IL further rises and exceeds the value rg3, the voltage CLV at the output terminal CL exceeds the threshold voltage Vf of the diode in the bidirectional diode circuit CDC with respect to the power supply voltage IOD_V. As a result, the current detection circuit L_ID collapses, and the overcurrent signal changes to a low level again.

On the other hand, when the current IL flowing through the power transistor L_PN reaches the value rg1_1, the voltage at node L_ND4 reaches the over-range threshold, and the over-range signal L_OV changes from low to high level. When the current IL reaches the value rg3, the overcurrent signal changes to low level again as mentioned earlier, but before that, the over-range signal L_OV becomes high, and the over-range current L_OVI is supplied to the overcurrent comparison circuit 6_LIC. As a result, the error signal L_EER maintains a high level even if the current IL exceeds the value rg3, indicating that the occurrence of overcurrent due to the short circuit to power supply, etc., is continuing. Also, by maintaining the high level of the error signal L_EER, the drive circuit 4 shown in FIG. 1 continues to keep the power transistor L_PN in the off state.

### Self-Diagnosis Function

Describe the self-diagnosis function according to the first embodiment. Here, the function of diagnosing the circuit blocks added in the first embodiment compared to Comparative Examples 2 and 4 is explained.

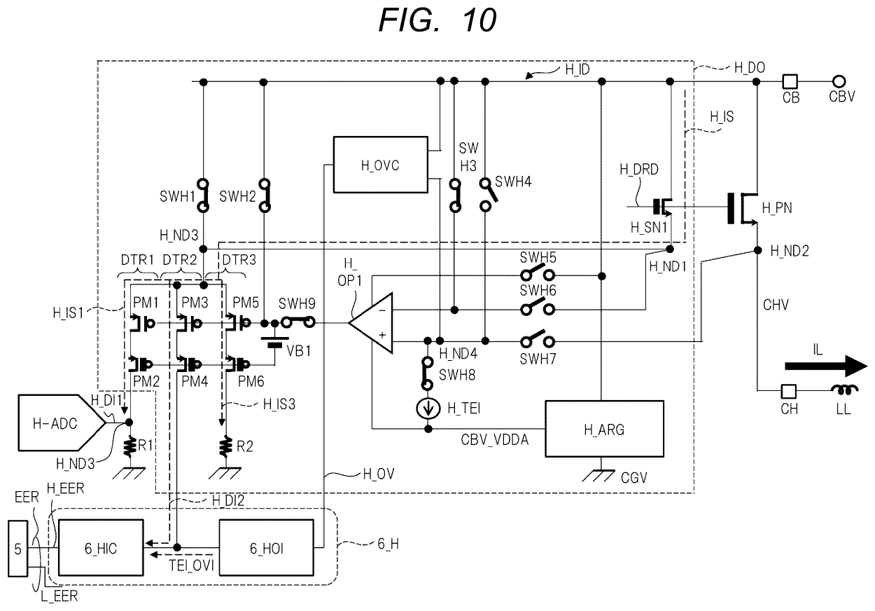

FIG. 10 is a circuit diagram showing the state of the high-side detection circuit during self-diagnosis according to the first embodiment. The differences between FIG. 10 and FIG. 2 are that in FIG. 10, the states of switches SWH1 to SWH3 and SWH5 to SWH8 differ from those in FIG. 2, and the over-range current TEI_OVI during diagnosis is shown.

Switches SWH1 to SWH9 are not particularly limited but are composed of N-channel type field-effect transistors and are switch-controlled by the control signal CNTs output from the control circuit 10 shown in FIG. 1. Switches SWH1 to SWH9 are used to prevent the semiconductor device from being destroyed during the switching of power transistor H_PN and to forcibly supply overcurrent to a predetermined location during self-diagnosis.

The circuit blocks to be diagnosed include a current path section that generates the second detection current H_DI2, an over-range comparison circuit H_OVC, an over-range current source 6_HOI, and an overcurrent comparison circuit 6_HIC, which will be explained as examples.

The current path section to be diagnosed is composed of P-type transistors PM1 to PM6, and this current path section is used to detect current during normal operation. Therefore, diagnosis is executed during normal operation. For the circuit blocks to be diagnosed, excluding the current path section, overcurrent is forcibly supplied to the over-range comparison circuit H_OVC during self-diagnosis, and diagnosis is performed based on the output (abnormal signal H_EER) at this time.

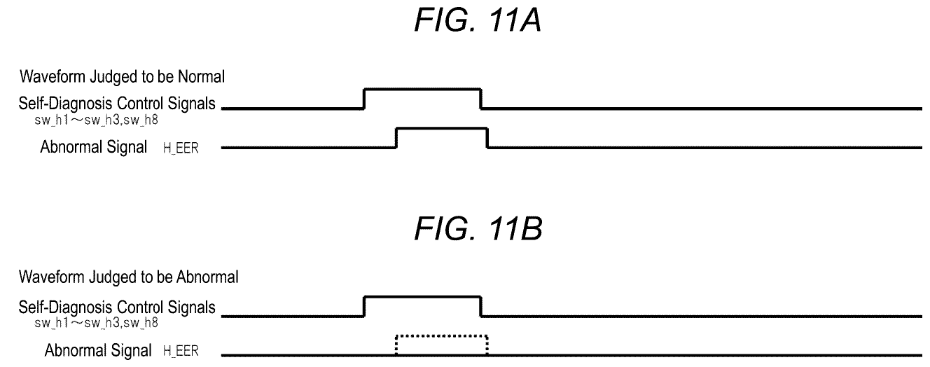

FIG. 11 is a waveform diagram for explaining the self-diagnosis function of the high-side detection circuit according to the first embodiment. Here, FIG. 11A shows a waveform judged to be normal during self-diagnosis, and FIG. 11B shows a waveform judged to be abnormal during self-diagnosis. The control circuit 10 (FIG. 1) outputs self-diagnosis control signals sw_h1 to sw_h9 (corresponding one-to-one to switches SWH1 to SWH9) as control signals CNTs, which turn on switches SWH1 to SWH3 and SWH8 and turn off other switches SWH4 to SWH7 and SWH9 during self-diagnosis. FIG. 11 shows only the self-diagnosis control signals sw_h1 to sw_h3, sw_h8 for turning on switches SWH1 to SWH3 and SWH8.

Switches SWH1 to SWH3 and SWH8 are turned on, and other switches SWH4 to SWH7 and SWH9 are turned off, resulting in the state shown in FIG. 10. Since switches SWH4 to SWH7 and SWH9 are turned off, the operational amplifier H_OP1 no longer performs feedback control. Therefore, self-diagnosis is performed at the start-up of the semiconductor device 1, etc. For example, control circuit 10 outputs self-diagnosis control signals as shown in FIG. 11 when the power supply voltage CBV is applied to the semiconductor device 1.

The self-diagnosis control signal sw_h8 turns on switch SWH8, thereby connecting the current source H_TEI to the over-range comparison circuit H_OVC through this switch SWH8. As a result, the voltage at node H_ND4 decreases. If the over-range comparison circuit H_OVC, over-range current source 6_HOI, overcurrent comparison circuit 6_HIC, and current path section (P-type transistors PM1 to PM6) are normal, the abnormal signal H_EER becomes high level as shown in FIG. 11A. On the other hand, if at least one of the over-range comparison circuit H_OVC, over-range current source 6_HOI, overcurrent comparison circuit 6_HIC, and current path section is abnormal, the abnormal signal H_EER becomes low level as shown in FIG. 11B.

The abnormal signal during self-diagnosis is supplied to the control circuit 10, for example, and is notified to the outside of the semiconductor device 1 as a result of self-diagnosis from the control circuit 10 at the start-up of the semiconductor device 1.

### Low-Side Detection Circuit

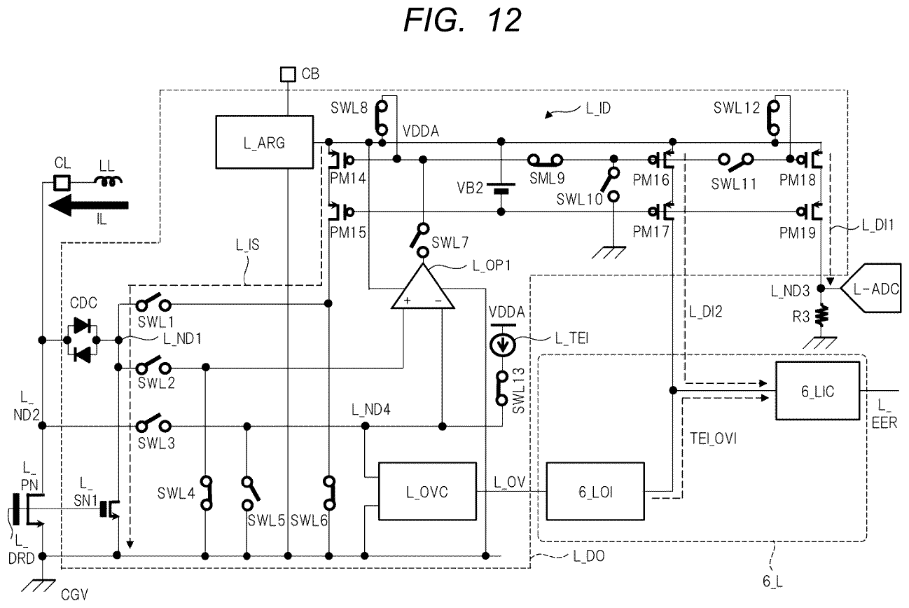

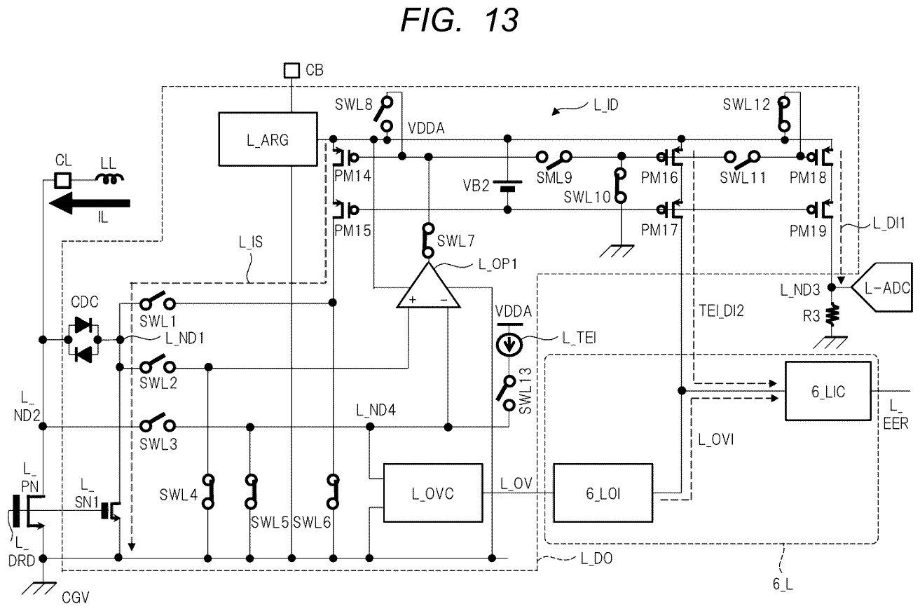

FIGS. 12 and 13 are circuit diagrams showing the state during self-diagnosis of the low-side detection circuit according to the first embodiment. The differences between FIGS. 12 and 13 and FIG. 5 are that in FIGS. 12 and 13, the states of switches SWL1 to SWL13 differ from those in FIG. 5, and the over-range current TEI_OVI and the second detection current TEI_DI2 during diagnosis are shown in FIGS. 12 and 13.

Switches SWL1 to SWL13 are not particularly limited but are composed of N-channel type field-effect transistors and are switch-controlled by the control signal CNTs output from the control circuit 10 shown in FIG. 1. Switches SWL1 to SWL13 are used to prevent the semiconductor device from being destroyed during the switching of power transistor L_PN and to forcibly flow current during self-diagnosis.

The circuit blocks to be diagnosed include a current mirror that generates the second detection current L_DI2, an over-range comparison circuit L_OVC, an over-range current source 6_LOI, and an overcurrent comparison circuit 6_LIC, which will be explained as examples.

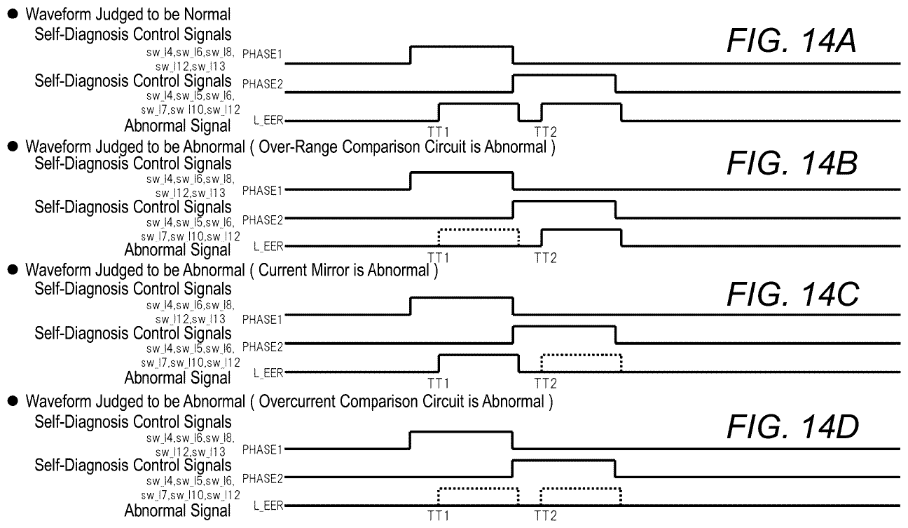

FIG. 14 is a waveform diagram for explaining the self-diagnosis function of the low-side detection circuit according to the first embodiment. Here, FIG. 14A shows a waveform judged to be normal during self-diagnosis, and FIGS. 14B to 14D show waveforms judged to be abnormal during self-diagnosis. That is, FIG. 14B shows the waveform when the over-range comparison circuit is abnormal, FIG. 14C shows the waveform when the current mirror is abnormal, and FIG. 14D shows the waveform when the overcurrent comparison circuit is abnormal.

The self-diagnosis of the low-side detection circuit is executed in two stages (Phase 1 (PHASE1) and Phase 2 (PHASE2)).

In Phase 1, the control circuit 10 outputs self-diagnosis control signals (sw_14, sw_16, sw_18, sw_112, sw_113) to turn on switches SWL4, SWL6, SWL8, SWL12, and SWL13, and self-diagnosis control signals to turn off other switches as control signals CNTs. The state of the detection circuit during Phase 1 is shown in FIG. 12. On the other hand, in Phase 2, the control circuit 10 outputs self-diagnosis control signals (sw_14, sw_15, sw_16, sw_17, sw_110, sw_112) to turn on switches SWL4, SWL5, SWL6, SWL7, SWL10, and SWL12, and self-diagnosis control signals to turn off other switches as control signals CNTs. The state of the detection circuit during Phase 2 is shown in FIG. 13.

In Phase 1, as shown in FIG. 12, switch SWL13 is turned on, so the current source L_TEI is connected to the over-range comparison circuit L_OVC through switch SWL13. As a result, current is forcibly supplied to the over-range comparison circuit L_OVC. If the over-range comparison circuit L_OVC and over-range current source 6_LOI are normal, the over-range current TEI_OVI (FIG. 12) is output, and if the overcurrent comparison circuit 6_LIC is also normal, the abnormal signal L_EER becomes high level at timing TT1 in response to the Phase 1 self-diagnosis control signal, as shown in FIG. 14A. On the other hand, in Phase 2, as shown in FIG. 13, switch SWL10 is turned on. As a result, the P-type transistor PM16 constituting the current mirror is turned on, and if this current mirror is normal, the second detection current TEI_DI2 (FIG. 13) flows, and if the overcurrent comparison circuit 6_LIC is also normal, the abnormal signal L_EER becomes high level at timing TT2 in response to the Phase 2 self-diagnosis control signal, as shown in FIG. 14A.

On the other hand, for example, if there is an abnormality in the over-range comparison circuit L_OVC, the abnormal signal L_EER becomes low level at timing TT1, as shown in FIG. 14B. Also, if there is an abnormality in the current mirror, the abnormal signal L_EER becomes low level at timing TT2, as shown in FIG. 14C. Furthermore, if there is an abnormality in the overcurrent comparison circuit 6_LIC, the abnormal signal L_EER becomes low level at both timing TT1 and timing TT2.

As with the high-side detection circuit, the abnormal signal during self-diagnosis is supplied to the control circuit 10, for example, and is notified to the outside of the semiconductor device 1 as a result of self-diagnosis from the control circuit 10 at the start-up of the semiconductor device 1. The self-diagnosis for the low-side detection circuit may start from either Phase 1 or Phase 2. Also, when performing self-diagnosis on both the high-side and low-side detection circuits, the self-diagnosis may start from either detection circuit.

In the first embodiment, not only the second detection current (H_DI2, L_DI2) but also the over-range signal (H_OV, L_OV) based on the voltage of the power transistor (H_PN, L_PN) is used to detect overcurrent flowing through the power transistor. As a result, it is possible to detect overcurrent caused by a short circuit (short circuit to ground, short circuit to power supply) at the output terminal, which cannot be detected by the second detection current alone. It is also possible to detect overcurrent by detecting only the voltage of the power transistor, but in this case, it is required to convert the voltage to current, which may limit the conversion accuracy, and the accuracy of the threshold for detecting overcurrent may deteriorate. In contrast, in the first embodiment, since the second detection current, which does not require conversion to current, is also used to detect overcurrent, it is possible to prevent the accuracy of the threshold for detecting overcurrent from deteriorating. For example, in FIGS. 8 and 9, the threshold for detecting overcurrent consists of two thresholds: the overcurrent threshold and the overrange threshold, with the overcurrent threshold being more precisely set according to the desired threshold.

For example, the symbols of the transistors shown in FIGS. 1 to 7 are drawn to match the actual size and structure (gate oxide film) of the transistors. For example, in FIGS. 2 and 5, the symbols for the power transistors H_PN and L_PN are larger than those for the sense transistors H_SN1 and L_SN1. This indicates that the size of the power transistors is larger than that of the sense transistors.

Additionally, in the transistor symbols, the thickness of the vertical line representing the gate is drawn to match the thickness of the transistor's gate oxide film. For example, in FIGS. 2 to 4, the vertical lines representing the gates of P-type transistors PM1, PM3, PM5, PM7 to PM12, and N-type transistors NM1 to NM3 are thinner compared to the vertical lines representing the gates of P-type transistors PM2, PM4, PM6, and N-type transistors H_SN1, H_PN. This indicates that the gate oxide films of P-type transistors PM1, PM3, PM5, PM7 to PM12, and N-type transistors NM1 to NM3 are thinner and are low-voltage transistors compared to P-type transistors PM2, PM4, PM6, and sense transistor H_SN1, power transistor H_PN. This is also the case in FIGS. 5 to 7.

As shown in FIGS. 3 to 4 and FIGS. 6 to 7, by configuring the overrange comparison circuits H_OVC, L_OVC, overrange current sources 6_HOI, 6_LOI, and overcurrent comparison circuits 6_HIC, 6_LIC with low-voltage transistors in a simple circuit, it is possible to suppress the increase in occupied area and achieve miniaturization. Additionally, the high-voltage sense transistors require only one for each of the high side and low side, further suppressing the increase in occupied area and enabling miniaturization.

Furthermore, in Comparative Example 1, as shown in FIG. 19, it was necessary to supply voltage CPV from the charge pump circuit to the overcurrent detection circuit H_OID, but in Embodiment 1, as shown in FIGS. 1 and 2, it is not necessary to supply voltage CPV to the high-side detection circuit H_DO. This makes it possible to reduce the occupied area of the charge pump circuit 3 (FIG. 1) that generates the voltage CPV.

According to the self-diagnosis function of Embodiment 1, it is possible to self-diagnose the overrange comparison circuits H_OVC, L_OVC, overrange current sources 6_HOI, 6_LOI, and overcurrent comparison circuits 6_HIC, 6_LIC, for example, at the startup of the semiconductor device, thereby providing a highly safe semiconductor device.

### Embodiment 2

In Embodiment 1, an example was shown where the second detection current of analog value (e.g., H_DI2 in FIG. 2) and the overrange current (H_OVI in FIG. 2) are added to detect overcurrent, but in Embodiment 2, an example is explained where overcurrent is detected by the logical OR of the second detection current of digital value and the overcurrent signal of digital value. It should be noted that the addition performed in Embodiment 1 can also be considered to be realized by an addition circuit configured by wired OR.

### High-Side Detection Circuit

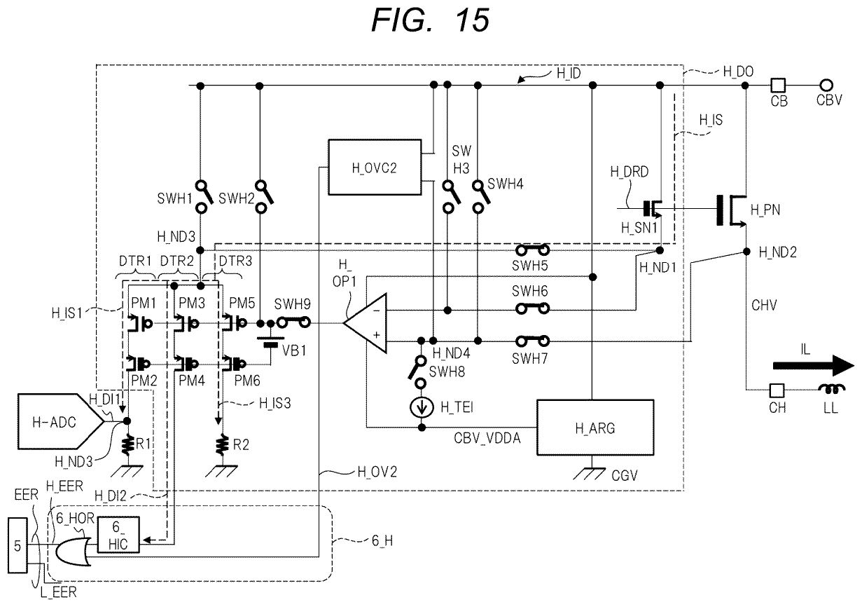

FIG. 15 is a circuit diagram showing the configuration of a high-side detection circuit according to Embodiment 2. FIG. 15 is as with FIG. 2. The main difference is that in FIG. 15, the overrange comparison circuit is changed to a digital overrange comparison circuit H_OVC2, and the high-side generation circuit section 6_H is configured by the overcurrent comparison circuit 6_HIC and the digital OR circuit (logic circuit) 6_HOR.

The overcurrent comparison circuit 6_HIC is as with that described in Embodiment 1, for example, the configuration described in FIG. 4B. The difference is that in FIG. 4B, the sum of the second detection current H_DI2 and the overrange current H_OVI was supplied to the input HIC_I of the overcurrent comparison circuit 6_HIC, but in FIG. 15, only the second detection current H_DI2 is supplied to the input HIC_I of the overcurrent comparison circuit 6_HIC, and the output HIC_O of the overcurrent comparison circuit 6_HIC is connected to one input of the 2-input OR circuit 6_HOR.

The other input of the 2-input OR circuit 6_HOR is supplied with the overrange signal H_OV2 from the overrange comparison circuit H_OVC2. Thus, the OR circuit 6_HOR outputs a high-level abnormal signal H_EER when at least one of the overcurrent signal from the overcurrent comparison circuit 6_HIC and the overrange signal H_OV2 is at a high level (logic value 1).

Next, an example of the overrange comparison circuit H_OVC2 will be described with reference to the drawings.

### An Example Configuration of Overrange Comparison Circuit H_OVC2

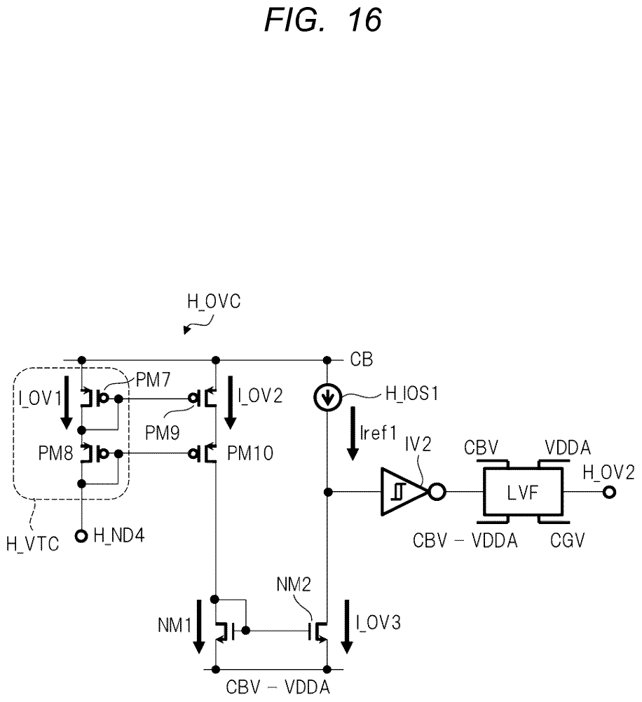

FIG. 16 is a circuit diagram showing the configuration of an overrange comparison circuit according to Embodiment 2. FIG. 16 is as with FIG. 3. The difference is that in FIG. 16, a Schmitt trigger type inverter circuit IV2 with hysteresis and a level shifter LVF are added to the overrange comparison circuit of FIG. 3. That is, in FIG. 16, the input of the inverter circuit IV2 is connected to the node connecting the constant current source H_IOS1 and the N-type transistor NM2, and the output of the inverter circuit IV2 is level-shifted by the level shifter LVF and supplied as the overrange signal H_OV2 to the other input of the OR circuit 6_HOR in the generation circuit section 6_H. The level shift circuit LVF is supplied with the power supply voltage CBV, the voltage CBV-VDDA, the voltage VDDA, and the ground voltage CGV. Thus, the level shift circuit LVF converts the output of the inverter circuit IV2, which varies between the power supply voltage CBV and the voltage CBV, into a digital overrange signal H_OV2 that varies between the voltage VDDA and the ground voltage CGV.

Thus, according to Embodiment 2, it is possible to generate an abnormal signal H_EER by the logical OR of digital signals.

### Low-Side Detection Circuit

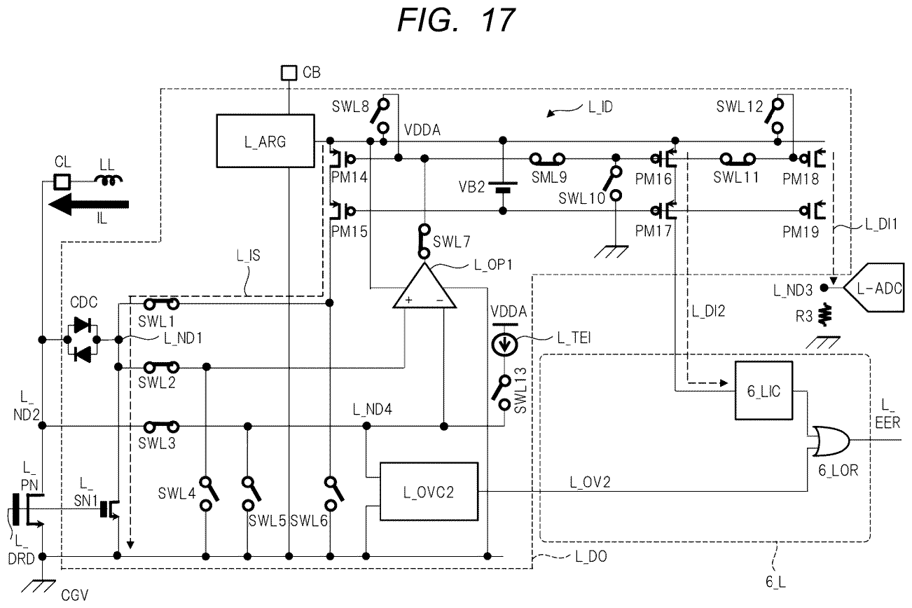

FIG. 17 is a circuit diagram showing the configuration of a low-side detection circuit according to Embodiment 2. FIG. 17 is as with FIG. 5. The main difference is that in FIG. 17, the overrange comparison circuit is changed to a digital overrange comparison circuit L_OVC2, and the low-side generation circuit section 6_L is configured by the overcurrent comparison circuit 6_LIC and the digital OR circuit (logic circuit) 6_LOR.

The overcurrent comparison circuit 6_LIC is as with that described in Embodiment 1, for example, the configuration described in FIG. 7B. The difference is that in FIG. 7B, the sum of the second detection current L_DI2 and the overrange current L_OVI was supplied to the input LIC_I of the overcurrent comparison circuit 6_LIC, but in FIG. 17, only the second detection current L_DI2 is supplied to the input LIC_I of the overcurrent comparison circuit 6_LIC, and the output LIC_O of the overcurrent comparison circuit 6_LIC is connected to one input of the 2-input OR circuit 6_LOR.

The other input of the 2-input OR circuit 6_LOR is supplied with the overrange signal L_OV2 from the overrange comparison circuit L_OVC2. Thus, the OR circuit 6_LOR outputs a high-level abnormal signal L_EER when at least one of the overcurrent signals from the overcurrent comparison circuit 6_LIC and the overrange signal L_OV2 is at a high level (logic value 1). Next, an example of the overrange comparison circuit L_OVC2 will be described with reference to the drawings.

### An Example Configuration of Overrange Comparison Circuit L_OVC2

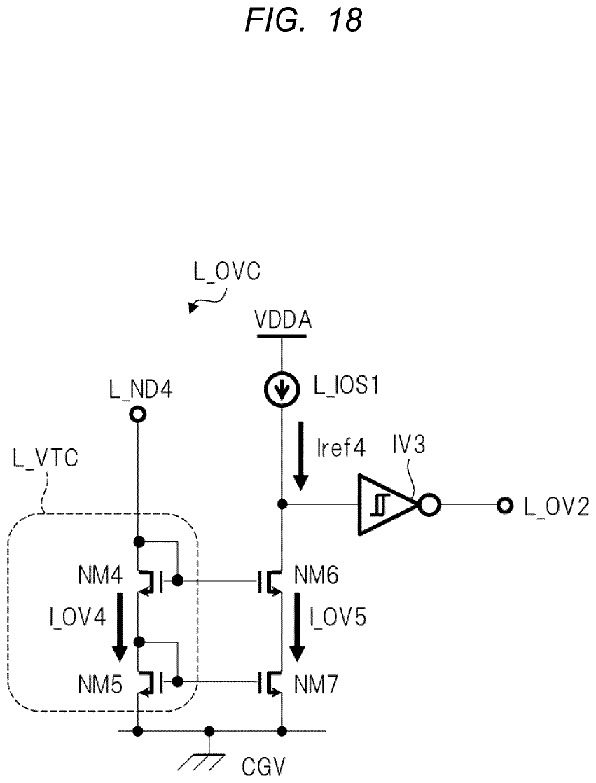

FIG. 18 is a circuit diagram showing the configuration of an overrange comparison circuit according to Embodiment 2. FIG. 18 is as with FIG. 6. The difference is that in FIG. 18, a Schmitt trigger type inverter circuit IV3 with hysteresis is added to the overrange comparison circuit shown in FIG. 6. That is, in FIG. 18, the input of the inverter circuit IV3 is connected to the node connecting the constant current source L_IOS1 and the N-type transistor NM6, and the overrange signal L_OV2 is output from the inverter circuit IV3. When overcurrent occurs, the voltage at node L_ND4 rises, increasing the current I_OV5 beyond the reference current Iref4. As a result, the overrange signal L_OV2 changes to a high level.

Thus, according to Embodiment 2, it is possible to generate an abnormal signal L_EER by the logical OR of digital signals.

In Embodiment 2, as described in the self-diagnosis function of Embodiment 1, a self-diagnosis function may also be provided.

In Embodiment 1, the second detection current and the overrange current were added analogously to generate an abnormal signal. In contrast, in Embodiment 2, the abnormal signal is generated by the logical OR of digital signals. This is more advantageous in terms of occupied area, current consumption, and speed compared to Embodiment 1. While the invention made by the present inventor has been specifically described based on the embodiments, it goes without saying that the present invention is not limited to the above embodiments and various modifications can be made without departing from the gist thereof.

What is claimed is:

1. A semiconductor device comprising:
a power device that supplies current to a load;
a current detection circuit that detects current flowing through the power device;
a device control circuit that controls the current flowing through the power device based on a first detection current detected by the current detection circuit and an input signal;
an overrange comparison circuit that outputs an overrange signal when the voltage of the power device exceeds a predetermined voltage, and
an abnormal signal generation circuit that outputs an abnormal signal indicating an overcurrent state of the power device based on a second detection current detected by the current detection circuit and the overrange signal.

2. The semiconductor device according to claim 1,
wherein the power device includes a power transistor having a pair of terminals including a terminal connected to the load and a gate terminal connected to the device control circuit,
wherein the current detection circuit includes a sense transistor having a pair of terminals and a gate terminal connected to the gate terminal of the power transistor, and generates the first detection current and the second detection current based on the current flowing between the pair of terminals of the sense transistor, and
wherein the overrange comparison circuit compares the voltage between the pair of terminals of the power transistor with the predetermined voltage and outputs the overrange signal when the voltage between the terminals exceeds the predetermined voltage.

3. The semiconductor device according to claim 2,
wherein the power transistor includes a first power transistor having one terminal connected to a first voltage terminal to which a first voltage is supplied, another terminal connected to a load terminal to which the load is connected, and a gate terminal connected to the device control circuit,
wherein the sense transistor includes a first sense transistor having one terminal connected to the first voltage terminal and a gate terminal connected to the gate terminal of the first power transistor, and
wherein the current detection circuit includes a first control circuit that operates so that the voltage of the other terminal of the first sense transistor matches the voltage of the other terminal of the first power transistor, and the first control circuit generates the second detection current corresponding to the first power transistor.

4. The semiconductor device according to claim 2,
wherein the power transistor includes a second power transistor having another terminal connected to a second voltage terminal to which a second voltage is supplied, one terminal connected to a load terminal to which the load is connected, and a gate terminal connected to the device control circuit,
wherein the sense transistor includes a second sense transistor having another terminal connected to the second voltage terminal and a gate terminal connected to the gate terminal of the second power transistor, and
wherein the current detection circuit includes a bidirectional circuit connected between one terminal of the second power transistor and one terminal of the second sense transistor, which operates to match the terminal voltage between the pair of terminals of the second sense transistor with the terminal voltage between the pair of terminals of the second power transistor, and a second control circuit that operates so that the voltage of one terminal of the second sense transistor matches the voltage of one terminal of the second power transistor, and the second control circuit generates the second detection current corresponding to the second power transistor.

5. The semiconductor device according to claim 2,
wherein the abnormal signal generation circuit includes an overrange current source that outputs an overrange current corresponding to the overrange signal, an adder circuit that adds the second detection current and the overrange current, and an overcurrent comparison circuit that compares the output of the adder circuit with a predetermined current and outputs the abnormal signal.

6. The semiconductor device according to claim 2,
wherein the abnormal signal generation circuit includes an overcurrent comparison circuit that outputs an overcurrent signal when the second detection current exceeds a predetermined current, and a logic circuit that performs a logical OR between the overcurrent signal and the overrange signal and outputs it as the abnormal signal.

7. The semiconductor device according to claim 2, further comprising;
a switch that turns on during diagnosis according to a diagnostic signal, and
a current source connected to the overrange comparison circuit via the switch to supply current.

8. The semiconductor device according to claim 3,
wherein the power transistor includes a second power transistor having another terminal connected to a second voltage terminal to which a second voltage different from the first voltage is supplied, one terminal connected to a load terminal to which the load is connected, and a gate terminal connected to the device control circuit,
wherein the sense transistor includes a second sense transistor having another terminal connected to the second voltage terminal and a gate terminal connected to the gate terminal of the second power transistor,
wherein the current detection circuit includes a bidirectional circuit connected between one terminal of the second power transistor and one terminal of the second sense transistor, which operates to match the terminal voltage between the pair of terminals of the second sense transistor with the terminal voltage between the pair of terminals of the second power transistor, and a second control circuit that operates so that the voltage of one terminal of the second sense transistor matches the voltage of one terminal of the second power transistor, and
wherein the second control circuit generates the second detection current corresponding to the second power transistor.

9. The semiconductor device according to claim 8,
wherein the load terminal includes a first load terminal to which the first power transistor and the first sense transistor are connected, and a second load terminal to which the second power transistor and the second sense transistor are connected, and
wherein the load includes a coil connected between the first load terminal and the second load terminal.

10. The semiconductor device according to claim 9,
wherein the first power transistor, the second power transistor, the first sense transistor, and the second sense transistor are composed of N-channel type transistors, and
wherein the device control circuit includes a first regulator that operates based on the voltage at the first load terminal and a voltage higher than the first voltage, a first driver connected to the gate terminals of the first power transistor and the first sense transistor, operating based on the output voltage of the first regulator, a second regulator that operates based on the second voltage and the first voltage, and a second driver connected to the gate terminals of the second power transistor and the second sense transistor, operating based on the output voltage of the second regulator.
